(19) United States
(12) Patent Application Publication
(10) Pub. No.: US 2016/0343077 A1
(43) Pub. Date: Nov. 24, 2016

(54) Probabilistic Analysis Trading Platform Apparatuses, Methods and Systems

(71) Applicant: FMR LLC, Boston, MA (US)

(72) Inventors: Dmitry Bisikalo, Framingham, MA (US); Igor Nikolaev, Berlin (DE); Tom Mulligan, Co. Galway (IE)

(21) Appl. No.: 14/715,551

(22) Filed: May 18, 2015

(51) Int. Cl. G06Q 40/04

(52) U.S. Cl. CPC G06Q 40/04

(57) ABSTRACT

The Probabilistic Analysis Trading Platform Apparatuses, Methods and Systems (“PATP”) transforms model training request and security analysis request inputs via PATP components into model parameters data, model training response, order request, and security analysis response outputs. A security analysis request associated with a security may be obtained via security analysis component. Model parameters of a model associated with the security may be retrieved. Modified nodes of the model for which probabilities have been modified by expert input data associated with the security analysis request may be determined. Dependent nodes for each of the modified nodes may be determined. Probabilities associated with the dependent nodes may be recalculated and an output value associated with a result node of the model may be determined based on the recalculated probabilities. A trading action may be facilitated based on the output value.

This application for letters patent disclosure document describes inventive aspects that include various novel innovations (hereinafter “disclosure”) and contains material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

### FIELD

The present innovations generally address asset information technology, and more particularly, include Probabilistic Analysis Trading Platform Apparatuses, Methods and Systems.

### BACKGROUND

People own all types of assets, some of which are secured instruments to underlying assets. People have used exchanges to facilitate trading and selling of such assets. Computer information systems, such as NAICO-NET, Trade*Plus and E*Trade allowed owners to trade securities assets electronically.

### BRIEF DESCRIPTION OF THE DRAWINGS

Appendices and/or drawings illustrating various, non-limiting, example, innovative aspects of the Probabilistic Analysis Trading Platform Apparatuses, Methods and Systems (hereinafter “PATP”) disclosure, include:

FIGS. 1A-1B show a datagraph diagram illustrating embodiments of a data flow for the PATP;

FIG. 2 shows a logic flow diagram illustrating embodiments of a model training (MT) component for the PATP;

FIG. 3 shows a logic flow diagram illustrating embodiments of a security analysis (SA) component for the PATP;

FIG. 4 shows a block diagram illustrating embodiments of an individual security model for the PATP;

FIG. 5 shows a block diagram illustrating embodiments of an index security model for the PATP;

FIG. 6 shows a screenshot diagram illustrating embodiments of the PATP;

FIG. 7 shows a screenshot diagram illustrating embodiments of the PATP;

FIG. 8 shows a screenshot diagram illustrating embodiments of the PATP;

FIG. 9 shows a screenshot diagram illustrating embodiments of the PATP;

FIG. 10 shows a screenshot diagram illustrating embodiments of the PATP;

FIG. 11 shows a screenshot diagram illustrating embodiments of the PATP; and

FIG. 12 shows a block diagram illustrating embodiments of a PATP controller;

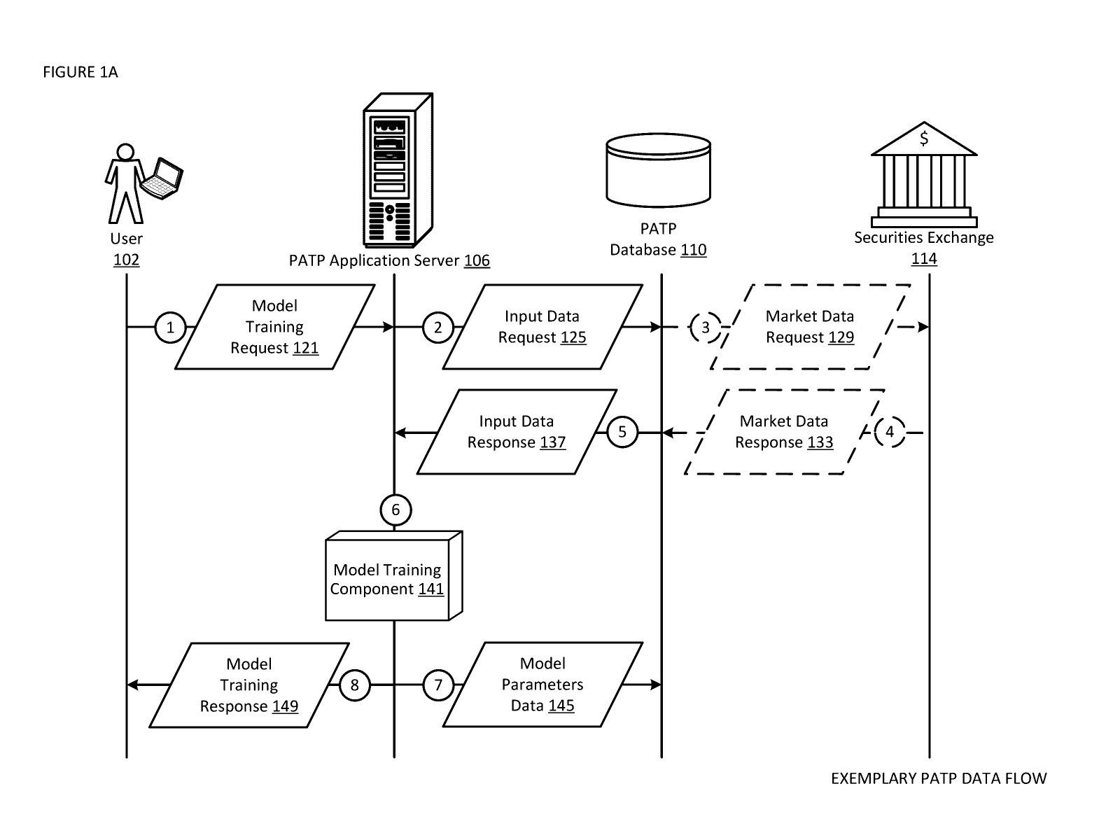

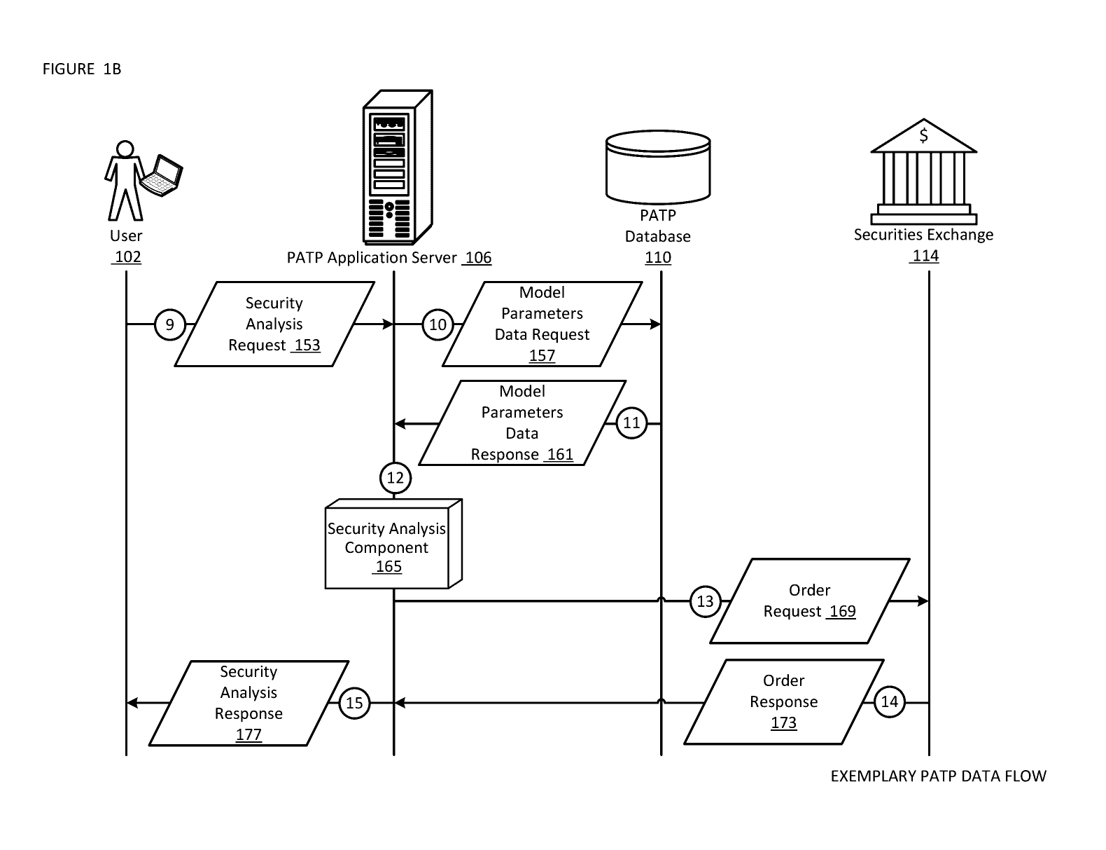

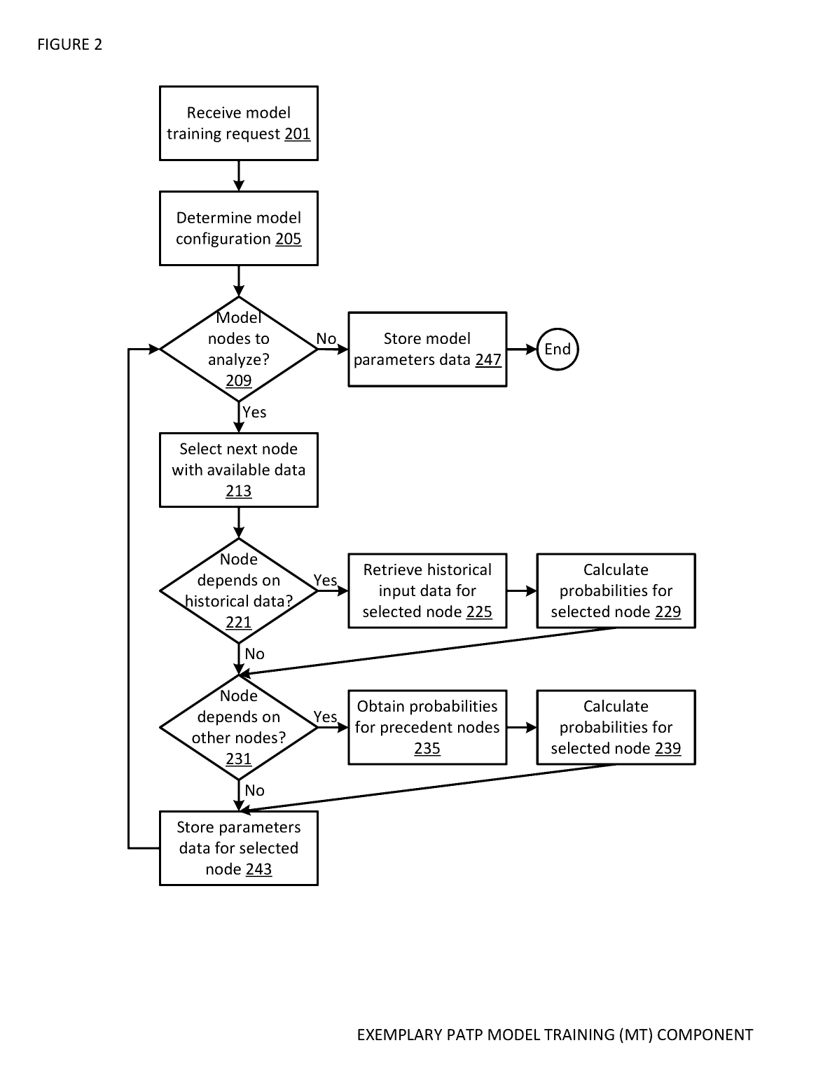

Generally, the leading number of each citation number within the drawings indicates the figure in which that citation number is introduced and/or detailed. As such, a detailed discussion of citation number 101 would be found and/or introduced in FIG. 1. Citation number 201 is introduced in FIG. 2, etc. Any citation and/or reference numbers are not necessarily sequences but rather just example orders that may be rearranged and other orders are contemplated.

### DETAILED DESCRIPTION

The Probabilistic Analysis Trading Platform Apparatuses, Methods and Systems (hereinafter “PATP”) transforms model training request and security analysis request inputs, via PATP components (e.g., MT, SA, etc.), into model parameters data, model training response, order request, and security analysis response outputs. The PATP components, in various embodiments, implement advantageous features as set forth below.

### Introduction

The PATP merges Probabilistic Graphical Models (PGMs) and fundamental financial analysis and/or trend analysis techniques to model (e.g., using a Bayesian network, historical data, and domain expert knowledge) the relationship between input parameters (e.g., fundamentals that describe company performance, trends in the trading volume and/or price of an index security) and goal probabilities (e.g., probabilities that the price of a security will overbid, stay on par with, or underbid the price of S&P 500 index), and to take trading actions based on determined goal probabilities. A model may be trained on historical data to define conditional probabilities between input parameters and goal probabilities, and may be self-adjusted on a sliding time window of available new data. In various embodiments, the PATP may be utilized to predict prices of individual securities (e.g., shares, bonds), index securities (e.g., Exchange Traded Funds (ETFs)), and/or the like using the trained model and/or domain expert knowledge. In various embodiments, the PATP may be utilized in applications such as high frequency trading (HFT), portfolio management, and/or the like.

### PATP

FIGS. 1A-1B show a datagraph diagram illustrating embodiments of a data flow for the PATP. In FIGS. 1A-1B, dashed lines indicate data flow elements that may be more likely to be optional. In FIG. 1A, a user 102 (e.g., a system administrator, a data scientist) may send a model training request 121 to a PATP application server 106. For example, the user may use a client (e.g., a desktop, a laptop, a tablet, a smartphone) to access a model training application (e.g., SamIam, R runtime environment, a website) and instruct the application to commence model training. In one implementation, the model training request may include data such as a request identifier, a user identifier, a password, model configuration data, and/or the like. For example, the client may provide the following example model training request, substantially in the form of a (Secure) Hypertext Transfer Protocol (“HTTP(S)”) POST message including eXtensible Markup Language (“XML”) formatted data, as provided below:

```
POST /model_training_request.php HTTP/1.1
Host: www.server.com
Content-Type: Application/XML
Content-Length: 667
<?XML version = “1.0” encoding = “UTF-8”?>
<model_training_request>
  <request_identifier>ID_request_1</request_identifier>
  <user_identifier>ID_DataScientist</user_identifier>
  <password>********</password>
  <model_configuration>
    <nodes>
      <node>
        <node_identifier>ID_Node1</node_identifier>
        <node_name>Price of X tomorrow compared to S&P
500</node_name>
        <node_inputs>
          <node_input>
            <input>Debt Ratio</input>
            <source>database with historical
data</source>
            <options>use 1 year of historical
data</options>
          </node_input>
          <node_input>
            <input>Liquidity</input>
            <source>database with historical
data</source>
            <options>use 1 year of historical
data</options>
          </node_input>
          <node_input>
          ...
          </node_input>
        </node_inputs>
        <node_outcomes>
          <node_outcome>Price < 90% S&P 500</node_outcome>
          <node_outcome>
            90% S&P 500 < Price < 110% S&P 500
          </node_outcome>
          <node_outcome>Price > 110% S&P 500</node_outcome>
        </node_outcomes>
      </node>
      <node>
      ...
      </node>
    </nodes>
  </model_configuration>
</model_training_request>
```

Based on the model training request, the PATP application server may send an input data request 125 to a PATP database 110. In one embodiment, the input data request may be sent to obtain historical input data from the PATP database. For example, input data may be obtained via a MySQL database command similar to the following:

SELECT debt_ratio, liquidity
FROM HistoricalData
WHERE security_identifier=“X” AND trade_date >
“1 year ago” AND trade_date <
“today”;

In some embodiments, the PATP database may send a market data request 129 to a securities exchange 114 to obtain market data. For example, such market data may be input data requested by the PATP application server. The securities exchange may provide the requested market data via a market data response 133 (e.g., via a market data feed).

The PATP database may send an input data response 137 to the PATP application server. The input data response may be used to provide the requested input data to the PATP application server. In one implementation, data in the input data response may be used directly by the model training application. In another implementation, data in the input data response may be saved to a file (e.g., in a CSV file format) and the resulting file may be used by the model training application.

The model training request may instruct the PATP application server to conduct model training using the obtained historical input data. Model training may be conducted by a model training (MT) component 141. See FIG. 2 for additional details regarding the MT component.

The PATP application server may send model parameters data 145 to the PATP database to store model parameters of a trained model. For example, model parameters data may be stored via a MySQL database command similar to the following:
INSERT INTO Models (modelID, modelParameters, modelSecurities, modelNodes) VALUES (ID_Model1, “parameters of the model”, “X”, “information regarding nodes in the model, such as inputs, outcomes, and calculated goal probabilities associated with each possible outcome for each node”);

The PATP application server may send a model training response 149 to the user. The model training response may be used to inform the user that the model training request has been processed. For example, the PATP application server may provide the following example model training response, substantially in the form of a HTTP(S) POST message including XML-formatted data, as provided below:

```
POST /model_training_response.php HTTP/1.1
Host: www.server.com
Content-Type: Application/XML
Content-Length: 667
<?XML version = “1.0” encoding = “UTF-8”?>
<model_training_response>
  <response_identifier>ID_response_1</response_identifier>
  <status>OK</status>
</model_training_response>
```

In FIG. 1B, a user 102 (e.g., a system administrator, a portfolio manager, an individual investor) may send a security analysis request 153 to a PATP application server 106. For example, the user may use a client to send the security analysis request to instruct the PATP application server to analyze a security. In one implementation, the security analysis request may include data such as a request identifier, a user identifier, a password, a security identifier, a model identifier, domain expert knowledge, and/or the like. For example, the client may provide the following example security analysis request, substantially in the form of a HTTP(S) POST message including XML-formatted data, as provided below:

```
POST /security_analysis_request.php HTTP/1.1
Host: www.server.com
Content-Type: Application/XML
Content-Length: 667
<?XML version = “1.0” encoding = “UTF-8”?>
<security_analysis_request>
  <request_identifier>ID_request_2</request_identifier>
  <user_identifier>ID_PortfolioManager</user_identifier>
  <password>********</password>
  <security_identifier>X</security_identifier>
  <model_identifier>ID_Model1</model_identifier>
  <domain_expert_input>debt ratio is below industry average
(<90%)</domain_expert_input>
</security_analysis_request>
```

The PATP application server may send a model parameters data request 157 to a PATP database 110. In one embodiment, the model parameters data request may be sent to obtain model parameters of the model used to analyze the security. For example, model parameters data may be obtained via a MySQL database command similar to the following:

SELECT *
FROM Models
WHERE modelID=“ID_Model1”;

The PATP database may send a model parameters data response 161 to the PATP application server. The model parameters data response may be used to provide the requested model parameters data to the PATP application server.

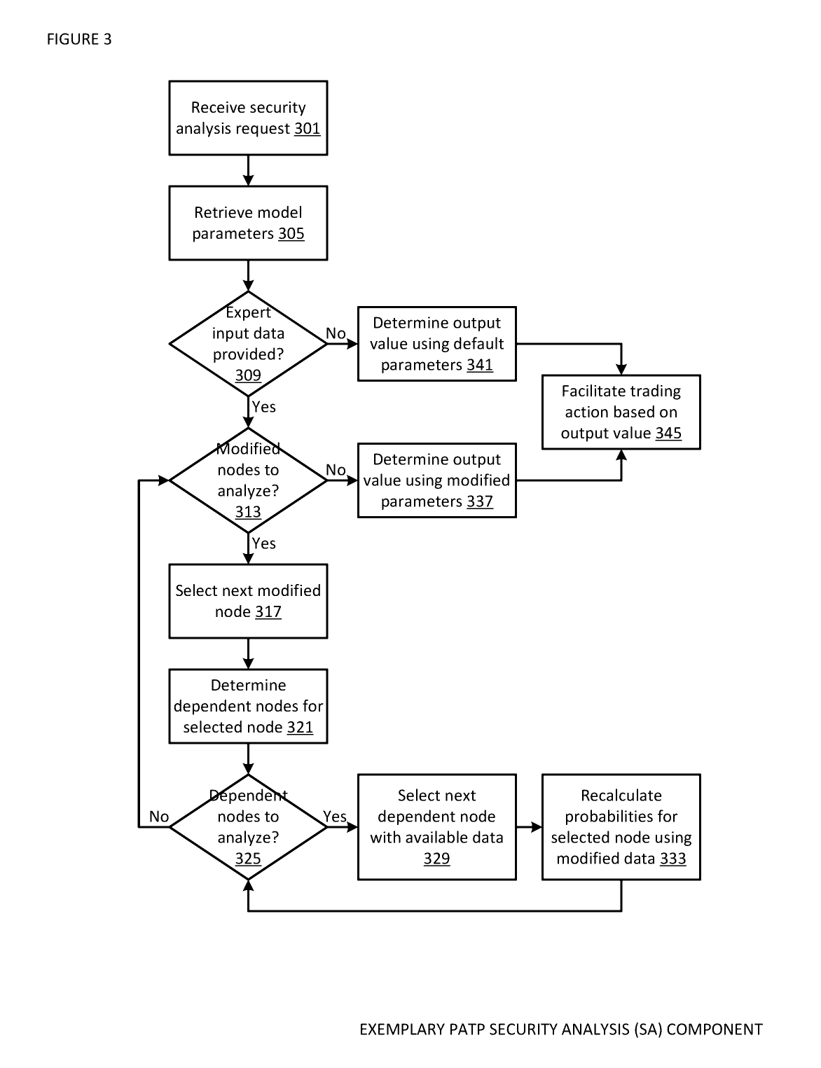

The security analysis request may instruct the PATP application server to analyze the security using the obtained model and/or the provided domain expert knowledge. Security analysis may be conducted by a security analysis (SA) component 165. See FIG. 3 for additional details regarding the SA component.

The PATP application server may send an order request 169 to a securities exchange 114 based on the results of the security analysis. In various embodiments, the order request may be sent to buy or sell the security, buy or sell options on the security, and/or the like. In one implementation, the order request may include data such as a request identifier, a security identifier, an order type, a quantity, a price, and/or the like. For example, the PATP application server may provide the following example order request, substantially in the form of a HTTP(S) POST message including XML-formatted data, as provided below:

```
POST /order_request.php HTTP/1.1
Host: www.server.com
Content-Type: Application/XML
Content-Length: 667
<?XML version = “1.0” encoding = “UTF-8”?>
<order_request>
  <request_identifier>ID_request_3</request_identifier>
  <security>X</security>
  <order_type>limit order</order_type>
  <quantity>100 shares</quantity>
  <price>$50</price>
</order_request>
```

The securities exchange may send an order response 173 to the PATP application server. The order response may be used to inform the PATP application server that the order has been processed. For example, the PATP application server may provide the following example order response, substantially in the form of a HTTP(S) POST message including XML-formatted data, as provided below:

```
POST /order_response.php HTTP/1.1
Host: www.server.com
Content-Type: Application/XML
Content-Length: 667
<?XML version = “1.0” encoding = “UTF-8”?>
<order_response>
  <response_identifier>ID_response_3</response_identifier>
  <status>OK</status>
</order_response>
```

The PATP application server may send a security analysis response 177 to the user. The security analysis response may be used to inform the user regarding the results of the security analysis and/or that the order has been processed. For example, the PATP application server may provide the following example security analysis response, substantially in the form of a HTTP(S) POST message including XML-formatted data, as provided below:

```
POST /security_analysis_response.php HTTP/1.1
Host: www.server.com
Content-Type: Application/XML
Content-Length: 667
<?XML version = “1.0” encoding = “UTF-8”?>
<security_analysis_response>
  <response_identifier>ID_response_2</response_identifier>
  <analysis_results>price of X is likely to be > 110% S&P
500</analysis_results>
  <status>limit order to buy 100 shares of X at up to $50 processed
OK</status>
</security_analysis_response>
```

FIG. 2 shows a logic flow diagram illustrating embodiments of a model training (MT) component for the PATP. In FIG. 2, a model training request may be received at 201. For example, a user may wish to train a model to determine goal probabilities for a security. Accordingly, the model training request may be received via a model training application utilized by the user via a client.

Model configuration for the model may be determined at 205. In one embodiment, the model training request may be parsed (e.g., using PHP commands) to determine the model configuration. For example, model configuration may include model name, security associated with the model, nodes associated with the model, node names, node dependencies, node inputs, historical data sources for inputs, node outcomes, and/or the like. In another embodiment, the model training request may be parsed to determine an identifier of an existing model and model configuration of the existing model may be retrieved (e.g., from a PATP database). For example, the user may specify the identifier of an existing model stored in the PATP database that the user wishes to retrain.

A determination may be made at 209 whether there remain model nodes to analyze. In one embodiment, each of the nodes in the model may be analyzed to estimate unconditional probabilities and/or conditional probabilities associated with the node's inputs and/or outcomes. If there remain model nodes to analyze, the next node with available data may be selected at 213. In some embodiments, nodes may depend on other nodes (e.g., nodes in the model may be arranged as an acyclic directed graph) and goal probabilities associated with precedent nodes may be calculated before analyzing dependent nodes. Accordingly, a node that relies on historical data and/or precedent nodes for which goal probabilities have been estimated may be selected.

A determination may be made at 221 whether the selected node depends on historical data. In one embodiment, inputs associated with the node may be analyzed to make this determination. In one implementation, if an input associated with the selected node is associated with a historical data source, the selected node depends on historical data. If it is determined that the selected node depends on historical data, historical input data for the selected node may be retrieved at 225 (e.g., via a MySQL database command), and probabilities for the selected node may be calculated at 229. In one embodiment, unconditional probabilities may be estimated. For example, one of the inputs associated with the selected node may be debt ratio associated with the security. Unconditional probabilities for this input may be calculated based on the proportions of time (e.g., percent of days over the past year) that debt ratio associated with the security was below (e.g., 20%), on par with (e.g., 50%), or above (e.g., 30%) industry average. In another embodiment, conditional probabilities may be estimated. For example, goal probabilities (e.g., probabilities that the price of the security will overbid, stay on par with, or underbid the price of S&P 500 index) associated with each possible outcome (e.g., Price>110% S&P 500 (overbid), 90% S&P 500<Price<110% S&P 500 (on par with), Price<90% S&P 500 (underbid)) may be conditionally dependent on probabilities associated with inputs. In one implementation, conditional probabilities for the outcomes may be calculated using a naive Bayes classifier.

A determination may be made at 231 whether the selected node depends on other nodes. In one embodiment, inputs associated with the node may be analyzed to make this determination. In one implementation, if an input associated with the selected node depends on goal probabilities associated with a precedent node, the selected node depends on other nodes. If it is determined that the selected node depends on other nodes, goal probabilities associated with precedent nodes may be obtained at 235 (e.g., by analyzing data structures associated with precedent nodes), and probabilities for the selected node may be calculated at 239. In one embodiment, conditional probabilities for the outcomes may be estimated based on probabilities associated with inputs (e.g., probabilities for inputs calculated using historical data, probabilities for inputs obtained based on data associated with precedent nodes). In one implementation, conditional probabilities for the outcomes may be calculated using a naive Bayes classifier.

Parameters data for the selected node may be stored at 243 (e.g., in a data structure). For example, parameters data for the selected node may include node name, node dependencies, node inputs, historical data sources for inputs, node outcomes, calculated goal probabilities associated with each possible outcome, and/or the like.

If it is determined that model nodes have been analyzed, model parameters data may be stored at 247 (e.g., in the PATP database). For example, model parameters data may include model configuration data, parameters data associated with the model's nodes, and/or the like.

FIG. 3 shows a logic flow diagram illustrating embodiments of a security analysis (SA) component for the PATP. In FIG. 3, a security analysis request may be received at 301. For example, a user may wish to analyze a security. Accordingly, the security analysis request may be received via an application (e.g., the model training application used in query mode, a portfolio management application that integrates trained models) utilized by the user via a client.

Model parameters may be retrieved at 305 (e.g., from a PATP database). In one embodiment, the security analysis request may be parsed to determine the identifier of the model for which model parameters should be retrieved. In another embodiment, the security analysis request may be parsed to determine the security that should be analyzed, and the model for which model parameters should be retrieved may be determined based on the security (e.g., each security may be associated with a model).

A determination may be made at 309 whether domain expert input data has been provided. In one embodiment, domain expert input data may be data provided by a domain expert (e.g., a portfolio manager, another PATP component that performs an analysis to generate expert data) that modifies probabilities associated with one or more nodes of the model. For example, domain expert input data may include probabilities for an input (e.g., debt ratio associated with the security) of a node, probabilities associated with possible outcomes (e.g., Price>110% S&P 500 (overbid), 90% S&P 500<Price<110% S&P 500 (on par with), Price<90% S&P 500 (underbid)) of a node, and/or the like. In one embodiment, the security analysis request may be parsed to determine whether domain expert input data has been provided.

If it is determined that domain expert input data has been provided, a determination may be made at 313 whether there remain modified model nodes to analyze. In one embodiment, each of the nodes in the model for which probabilities have been modified by the domain expert may be analyzed. If there remain modified model nodes to analyze, the next modified node may be selected at 317. If domain expert input data includes modified probabilities for an input of the selected modified node, probabilities for the selected modified node may be recalculated in a similar manner as described below with regard to 333. Dependent nodes for the selected modified node may be determined at 321. In one embodiment, each of the nodes that has an input that depends (e.g., directly or indirectly) on goal probabilities associated with the selected modified node may be determined.

A determination may be made at 325 whether there remain dependent nodes to analyze. In one embodiment, each of the dependent nodes may be analyzed to estimate modified unconditional probabilities and/or conditional probabilities associated with the dependent node's inputs and/or outcomes. If there remain dependent nodes to analyze, the next dependent node with available data may be selected at 329. In one embodiment, a dependent node that relies on historical data and/or precedent nodes for which goal probabilities have been estimated may be selected.

Probabilities for the selected dependent node may be recalculated using modified data at 333. In one embodiment, unconditional probabilities for inputs may be recalculated (e.g., based on updated historical data). In another embodiment, conditional probabilities for outcomes may be recalculated based on (e.g., directly or indirectly) modified goal probabilities associated with the selected modified node. In one implementation, conditional probabilities for the outcomes may be recalculated using a naive Bayes classifier.

If it is determined that modified nodes and/or associated dependent nodes have been analyzed, output value may be determined using recalculated probabilities at 337. In one embodiment, the output value may be goal probabilities (e.g., probabilities that the price of the security will overbid (30%), stay on par with (50%), or underbid (20%) the price of S&P index) associated with each possible outcome (e.g., Price>110% S&P 500 (overbid), 90% S&P 500<Price<110% S&P 500 (on par with), Price<90% S&P 500 (underbid)) of a leaf node (e.g., node indicating results of the analysis) associated with the security. In another embodiment, the output value may be the most likely outcome (e.g., stay on par with the price of S&P 500 index) of a leaf node (e.g., node indicating results of the analysis) associated with the security. If it is determined that domain expert input data has not been provided, output value may be determined using default probabilities at 341.

A trading action may be facilitated at 345 based on the output value. In one embodiment, the trading action may be based on the most likely outcome of a leaf node (e.g., node indicating results of the analysis) associated with the security. For example, if the most likely outcome is for the security to stay on par with the price of S&P 500 index, the trading action may be to buy options on the security. In another embodiment, the trading action may be based on threshold values of goal probabilities associated with each possible outcome of a leaf node (e.g., node indicating results of the analysis) associated with the security. For example, if the probability that the security overbids the price of S&P 500 index exceeds 25%, the trading action may be to buy shares of the security.

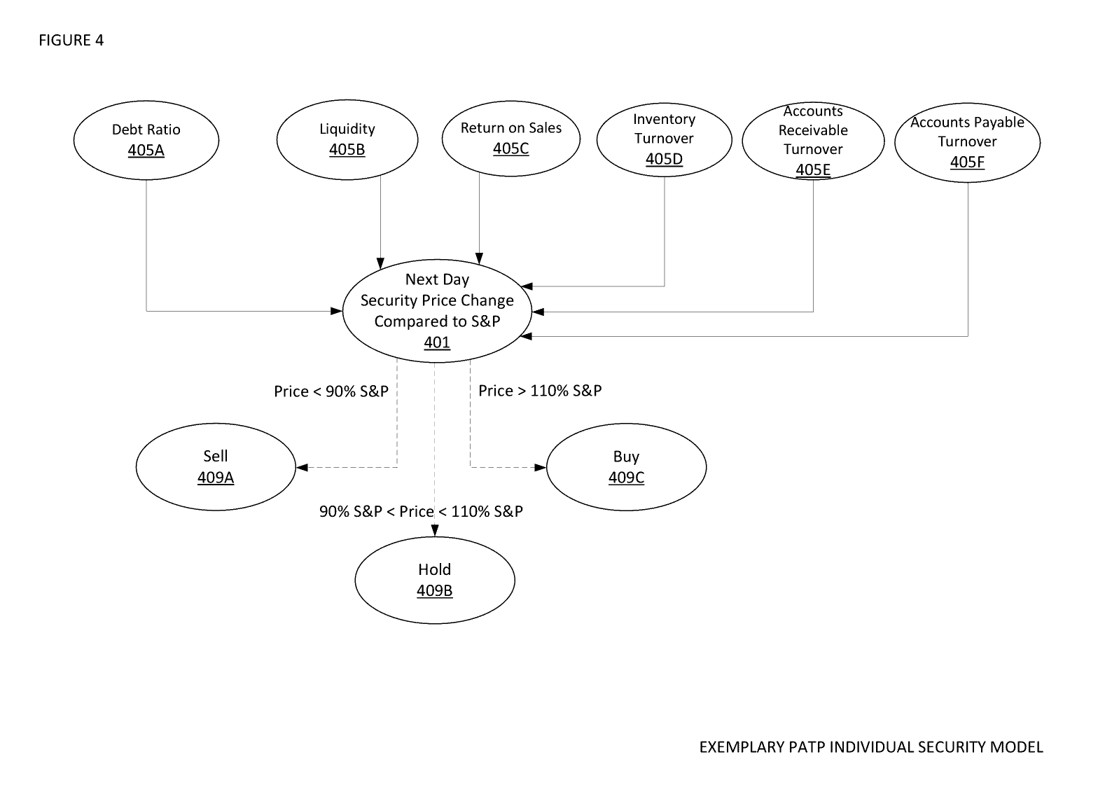

FIG. 4 shows a block diagram illustrating embodiments of an individual security model for the PATP. In FIG. 4, a model comprising one node 401 for estimating an individual security's next day security price change compared to S&P 500 goal probabilities for outcomes (e.g., Price>110% S&P 500 (overbid), 90% S&P 500<Price<110% S&P 500 (on par with), Price<90% S&P 500 (underbid)) is shown. The node has inputs that are based on fundamental financial analysis parameters including debt ratio 405A, liquidity 405B, return on sales 405C, inventory turnover 405D, accounts receivable turnover 405E, and accounts payable turnover 405F. In various embodiments, other fundamental financial analysis parameters may be used as inputs in addition to and/or instead of the inputs 405A-405F. In one implementation, inputs and outcomes may be represented as random variables (e.g., discreet random variables, continuous random variables). It is to be understood that a model based on fundamental financial analysis parameters may be used for index securities. Based on goal probabilities for outcomes, the model may recommend and/or facilitate a trading action, such as to sell 409A (e.g., if the most likely outcome is Price<90% S&P 500 (underbid)), hold 409B (e.g., if the most likely outcome is 90% S&P 500<Price<110% S&P 500 (on par with)), or buy 409C (e.g., if the most likely outcome is Price>110% S&P 500 (overbid)) the security.

In one embodiment, unconditional probabilities for inputs may be calculated using historical data. For example, debt ratio may be treated as a random variable having values below industry average (<90%), on par with industry average (90%-110%), above industry average (>110%), and historical data may be analyzed to determine the proportions of time (e.g., percent of days over the past year) that debt ratio associated with the security was below (e.g., 20%), on par with (e.g., 50%), or above (e.g., 30%) industry average. In another example, liquidity may be treated as a random variable having values below average, above average, and historical data may be analyzed to determine the proportions of time (e.g., percent of days over the past year) that liquidity associated with the security was below (e.g., 45%), or above (e.g., 55%) average.

The model may be trained to determine conditional probabilities between inputs and goal probabilities for outcomes, and may be self-adjusted on a sliding time window (e.g., past year) of available new data. The following notation and formulas are used:

$$P ( A \vert B ) - conditional probability , P ( A , B ) - joint probability , \\ P ( B ) - single probability$$

$$P ( A \vert B ) = P ( A , B ) / P ( B )$$

$$P ( {A}_{l} ) = {\sum }_{k = 1 , l = 1}^{n , m} P ( {A}_{l} \vert {B}_{k} , {C}_{l} ) * P ( {B}_{k} , {C}_{l} )$$

$$P ( {A}_{l} ) is a probability of event {A}_{l} . \\ And summation is over events {B}_{k} and {C}_{l} .$$

For example, conditional probabilities between debt ratio and liquidity inputs, and next day security price change compared to S&P 500 outputs may be determined based on historical data and represented as follows:

| | | | Conditional |
|---|---|---|---|
| Next Day Security % Change | | | Probability |
| Compare to S&P | Liquidity | Debt Ratio | Distribution |
| Bellow S&P (<90%) | Below Average | Bellow Industry Average (<90%) | 0.7 |
| On Par with S&P (90-110%) | Below Average | Bellow Industry Average (<90%) | 0.2 |
| Above S&P (>110%) | Below Average | Bellow Industry Average (<90%) | 0.1 |
| Bellow S&P (<90%) | Above Average | Bellow Industry Average (<90%) | 0.6 |
| On Par with S&P (90-110%) | Above Average | Bellow Industry Average (<90%) | 0.2 |
| Above S&P (>110%) | Above Average | Bellow Industry Average (<90%) | 0.2 |
| Bellow S&P (<90%) | Below Average | On Par with Industry Average (90-110%) | 0.6 |
| On Par with S&P (90-110%) | Below Average | On Par with Industry Average (90-110%) | 0.2 |
| Above S&P (>110%) | Below Average | On Par with Industry Average (90-110%) | 0.2 |
| Bellow S&P (<90%) | Above Average | On Par with Industry Average (90-110%) | 0.5 |
| On Par with S&P (90-110%) | Above Average | On Par with Industry Average (90-110%) | 0.3 |
| Above S&P (>110%) | Above Average | On Par with Industry Average (90-110%) | 0.2 |
| Bellow S&P (<90%) | Below Average | Above Industry Average (>110%) | 0.4 |
| On Par with S&P (90-110%) | Below Average | Above Industry Average (>110%) | 0.2 |
| Above S&P (>110%) | Below Average | Above Industry Average (>110%) | 0.4 |
| Bellow S&P (<90%) | Above Average | Above Industry Average (>110%) | 0.3 |
| On Par with S&P (90-110%) | Above Average | Above Industry Average (>110%) | 0.3 |
| Above S&P (>110%) | Above Average | Above Industry Average (>110%) | 0.4 |

Based on the above data and formulas, goal probabilities for outcomes may be calculated as follows:

$$P ( Bellow S \& P ( < 90 \% ) ) = {\sum }_{k = 1 , l = 1}^{2 , 3} P ( Bellow S \& P ( < 90 \% ) \vert {B}_{k} , {C}_{l} ) * P ( {B}_{k} , {C}_{l} ) = 50.5 \%$$

$$P ( On Par with S \& P ( 90 - 110 \% ) ) = {\sum }_{k = 1 , l = 1}^{2 , 3} P ( On Par with S \& P ( 90 - 110 \% ) \vert {B}_{k} , {C}_{l} ) * P ( {B}_{k} , {C}_{l} ) = 24.4 \%$$

$$P ( Above S \& P ( > 110 \% ) ) = {\sum }_{k = 1 , l = 1}^{2 , 3} P ( Above S \& P ( > 110 \% ) \vert {B}_{k} , {C}_{l} ) * P ( {B}_{k} , {C}_{l} ) = 25.1 \%$$

Accordingly, in this example, the most likely outcome is Price<90% S&P 500 (underbid).

The model may also handle probabilistic queries that include domain expert input data. For example, if a domain expert specifies that debt ratio is below industry average (probability of 100%) and liquidity is above average (probability of 100%), based on the above data and formulas, goal probabilities for outcomes may be calculated as 60% for Price<90% S&P 500 (underbid), 20% for 90% S&P 500<Price<110% S&P 500 (on par with), and 20% for Price>110% S&P 500 (overbid).

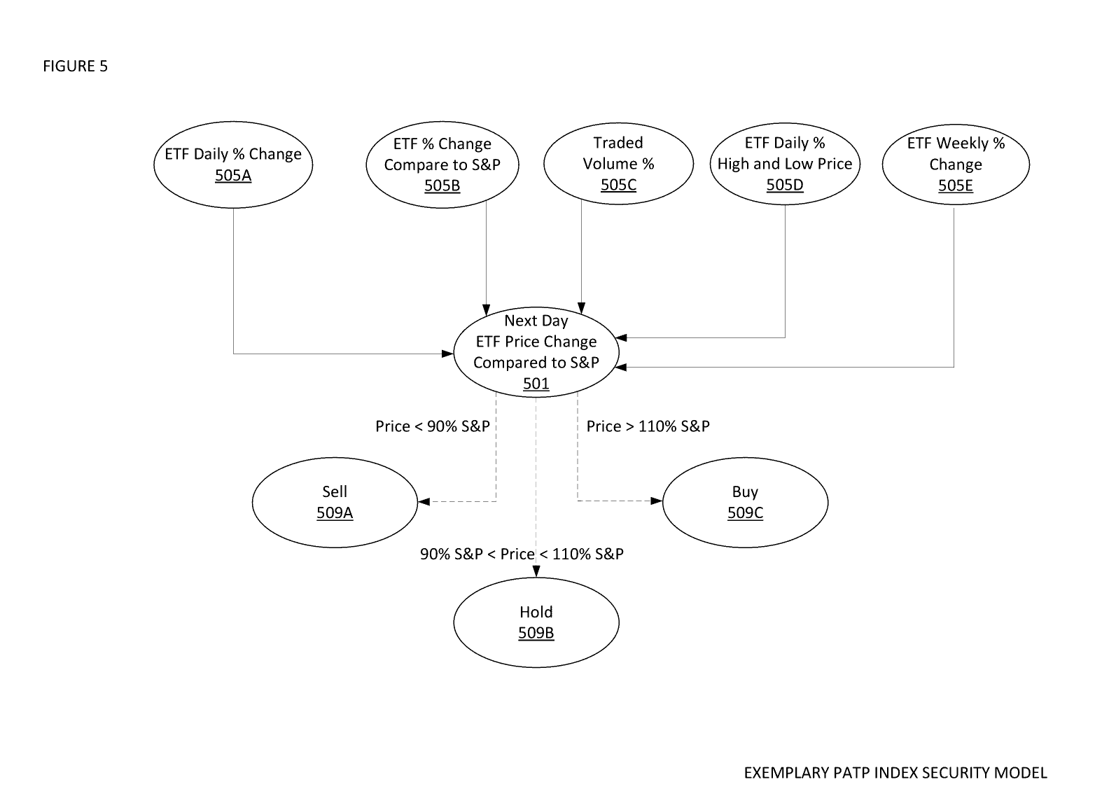

FIG. 5 shows a block diagram illustrating embodiments of an index security model for the PATP. In FIG. 5, a model comprising one node 501 for estimating an index security's (e.g., an ETF's) next day ETF price change compared to S&P 500 goal probabilities for outcomes (e.g., Price>110% S&P 500 (overbid), 90% S&P 500<Price<110% S&P 500 (on par with), Price<90% S&P 500 (underbid)) is shown. The node has inputs that are based on trend analysis parameters including ETF daily % change 505A, ETF % change compared to S&P 500 505B, traded volume % 505C, ETF daily % high and low prices 505D, and ETF weekly % change 505F. In various embodiments, other trend analysis parameters may be used as inputs in addition to and/or instead of the inputs 505A-505E. In one implementation, inputs and outcomes may be represented as random variables (e.g., discreet random variables, continuous random variables). It is to be understood that a model based on trend analysis parameters may be used for individual securities. Based on goal probabilities for outcomes, the model may recommend and/or facilitate a trading action, such as to sell 509A (e.g., if the most likely outcome is Price<90% S&P 500 (underbid)), hold 509B (e.g., if the most likely outcome is 90% S&P 500<Price<110% S&P 500 (on par with)), or buy 509C (e.g., if the most likely outcome is Price>110% S&P 500 (overbid)) the security.

In one embodiment, unconditional probabilities for inputs may be calculated using historical data. For example, ETF % change compared to S&P 500 may be treated as a random variable having values below S&P 500 (<90%), on par with S&P 500 (90%-110%), above S&P 500 (>110%), and historical data may be analyzed to determine the proportions of time (e.g., percent of days over the past year) that ETF % change compared to S&P 500 for the security was below (e.g., 20%), on par with (e.g., 50%), or above (e.g., 30%) S&P 500 price change. In another example, traded volume may be treated as a random variable having values below average, above average, and historical data may be analyzed to determine the proportions of time (e.g., percent of days over the past year) that traded volume for the security was below (e.g., 45%), or above (e.g., 55%) average.

The model may be trained to determine conditional probabilities between inputs and goal probabilities for outcomes, and may be self-adjusted on a sliding time window (e.g., past year) of available new data. The following notation and formulas are used:

$$P ( A \vert B ) - conditional probability , P ( A , B ) - joint probability , \\ P ( B ) - single probability$$

$$P ( A \vert B ) = P ( A , B ) / P ( B )$$

$$P ( {A}_{l} ) = {\sum }_{k = 1 , l = 1}^{n , m} P ( {A}_{l} \vert {B}_{k} , {C}_{l} ) * P ( {B}_{k} , {C}_{l} )$$

$$P ( {A}_{l} ) is a probability of event {A}_{l} . \\ And summation is over events {B}_{k} and {C}_{l} .$$

For example, conditional probabilities between ETF % change compared to S&P 500 and traded volume inputs, and next day ETF price change compared to S&P 500 outputs may be determined based on historical data and represented as follows:

| | | | Conditional |
|---|---|---|---|
| Future ETF % Change | | | Probability |
| Compared to S&P | Traded Volume | Daily ETF % Change Compare to S&P | Distribution |
| Bellow S&P (<90%) | Below Average | Bellow S&P (<90%) | 0.7 |
| On Par with S&P (90-110%) | Below Average | Bellow S&P (<90%) | 0.2 |
| Above S&P (>110%) | Below Average | Bellow S&P (<90%) | 0.1 |
| Bellow S&P (<90%) | Above Average | Bellow S&P (<90%) | 0.6 |
| On Par with S&P (90-110%) | Above Average | Bellow S&P (<90%) | 0.2 |
| Above S&P (>110%) | Above Average | Bellow S&P (<90%) | 0.2 |
| Bellow S&P (<90%) | Below Average | On Par with S&P (90-110%) | 0.6 |
| On Par with S&P (90-110%) | Below Average | On Par with S&P (90-110%) | 0.2 |
| Above S&P (>110%) | Below Average | On Par with S&P (90-110%) | 0.2 |
| Bellow S&P (<90%) | Above Average | On Par with S&P (90-110%) | 0.5 |
| On Par with S&P (90-110%) | Above Average | On Par with S&P (90-110%) | 0.3 |
| Above S&P (>110%) | Above Average | On Par with S&P (90-110%) | 0.2 |
| Bellow S&P (<90%) | Below Average | Above S&P (>110%) | 0.4 |
| On Par with S&P (90-110%) | Below Average | Above S&P (>110%) | 0.2 |
| Above S&P (>110%) | Below Average | Above S&P (>110%) | 0.4 |
| Bellow S&P (<90%) | Above Average | Above S&P (>110%) | 0.3 |
| On Par with S&P (90-110%) | Above Average | Above S&P (>110%) | 0.3 |
| Above S&P (>110%) | Above Average | Above S&P (>110%) | 0.4 |

Based on the above data and formulas, goal probabilities for outcomes may be calculated as follows:

$$P ( Bellow S \& P ( < 90 \% ) ) = {\sum }_{k = 1 , l = 1}^{2 , 3} P ( Bellow S \& P ( < 90 \% ) \vert {B}_{k} , {C}_{l} ) * P ( {B}_{k} , {C}_{l} ) = 50.5 \%$$

$$P ( On Par with S \& P ( 90 - 110 \% ) ) = {\sum }_{k = 1 , l = 1}^{2 , 3} P ( On Par with S \& P ( 90 - 110 \% ) \vert {B}_{k} , {C}_{l} ) * P ( {B}_{k} , {C}_{l} ) = 24.4 \%$$

$$P ( Above S \& P ( > 110 \% ) ) = {\sum }_{k = 1 , l = 1}^{2 , 3} P ( Above S \& P ( > 110 \% ) \vert {B}_{k} , {C}_{l} ) * P ( {B}_{k} , {C}_{l} ) = 25.1 \%$$

Accordingly, in this example, the most likely outcome is Price<90% S&P 500 (underbid).

The model may also handle probabilistic queries that include domain expert input data. For example, if a domain expert specifies that ETF % change compared to S&P 500 is below S&P 500 (<90%) (probability of 100%) and traded volume is above average (probability of 100%), based on the above data and formulas, goal probabilities for outcomes may be calculated as 60% for Price<90% S&P 500 (underbid), 20% for 90% S&P 500<Price<110% S&P 500 (on par with), and 20% for Price>110% S&P 500 (overbid).

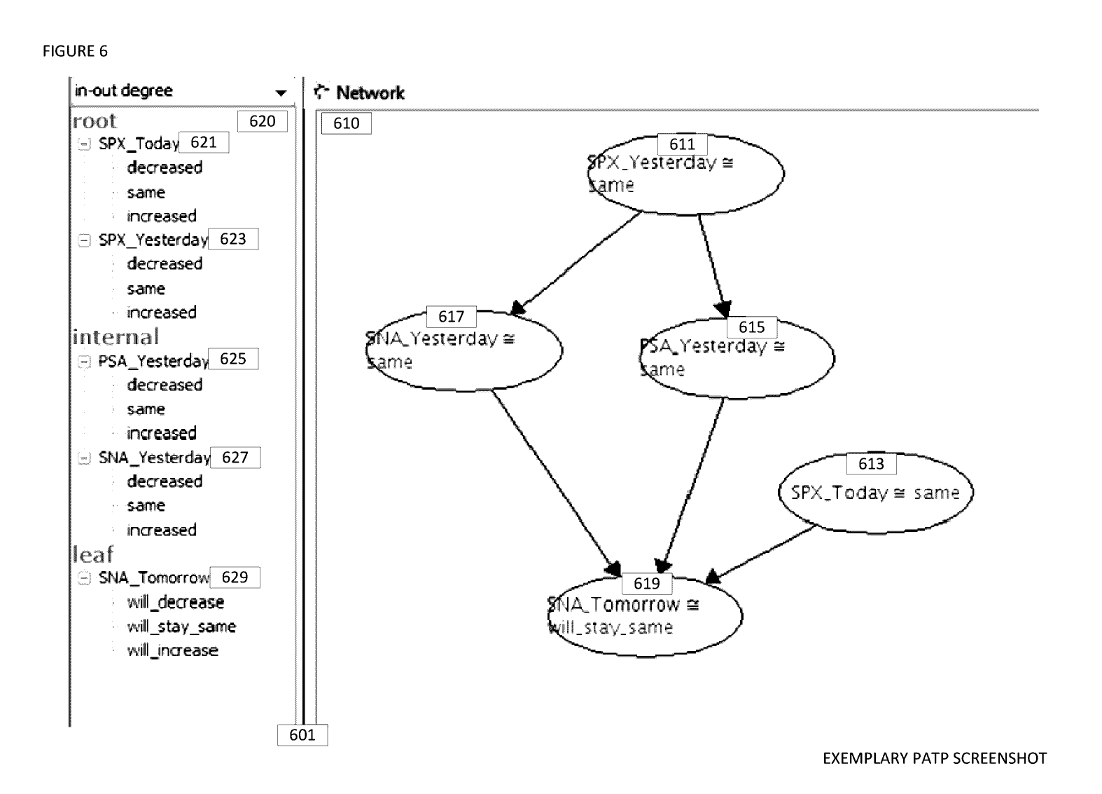

FIG. 6 shows a screenshot diagram illustrating embodiments of the PATP. In FIG. 6, an exemplary model training application 601 is shown. The model training application includes a model visualization section 610, which shows an exemplary model for predicting the price of security SNA tomorrow. The model includes nodes SPX_Today 611, SPX_Yesterday 613, PSA_Yesterday 615, SNA_Yesterday 617, and SNA_Tomorrow 619. The model training application includes a model configuration section 620, which shows node parameters SPX_Today 621, SPX_Yesterday 623, PSA_Yesterday 625, SNA_Yesterday 627, and SNA_Tomorrow 629. The nodes in this model represent random variables that reflect change in prices today and yesterday of securities SPX, SNA, and PSA. The random variables are discrete and can take one of three values: price decreased, price stayed the same, and price increased. As seen from the model, the most likely value for each of the nodes is for the price to stay the same. In one implementation, mapping from continuous price changes to discrete values may be done based on historical data on price changes for each individual security.

As seen from the model, node SNA_tomorrow (e.g., node indicating results of the analysis—predicting what happens to price of security SNA tomorrow—the most likely value is that the price will stay the same) is conditionally dependent on nodes SPX_Today, PSA_Yesterday and SNA_Yesterday. Nodes PSA_Yesterday and SNA_Yesterday are conditionally dependent on node SPX_Yesterday. In one embodiment, the conditional dependencies may be derived from historical data. Nodes SPX_Today and SPX_Yesterday are root nodes that do not depend on other nodes. Nodes PSA_Yesterday and SNA_Yesterday are internal nodes that depend on other nodes and have other dependent nodes. Node SNA_tomorrow is a leaf node that does not have other dependent nodes.

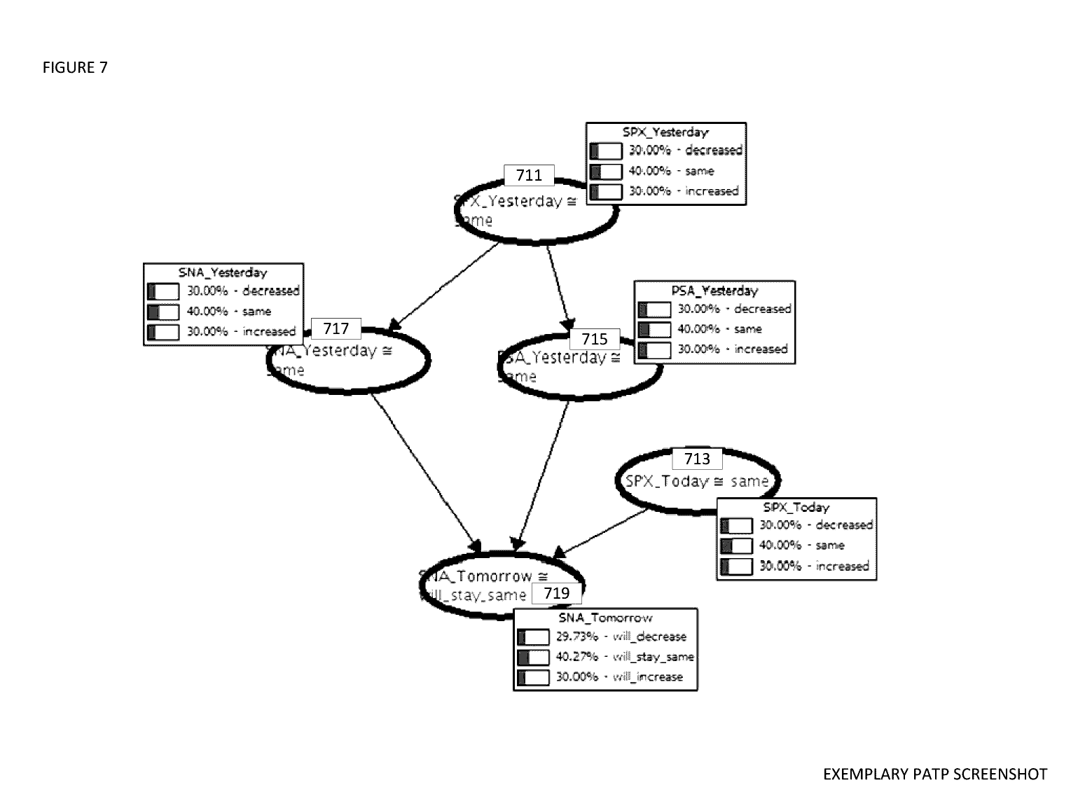

FIG. 7 shows a screenshot diagram illustrating embodiments of the PATP. In FIG. 7, additional details for the model shown in FIG. 6 are provided. Expected probabilities associated with nodes SPX_Today 711, SPX_Yesterday 713, PSA_Yesterday 715, SNA_Yesterday 717, and SNA_Tomorrow 719 are shown. Based on the probabilities for nodes SPX_Today, SPX_Yesterday, PSA_Yesterday and SNA_Yesterday (e.g., price decreased 30%, price stayed the same 40%, and price increased 30%), the probabilities for node SNA_Tomorrow are determined (e.g., price will decreased 29.73%, price will stay the same 40.27%, and price will increase 30%).

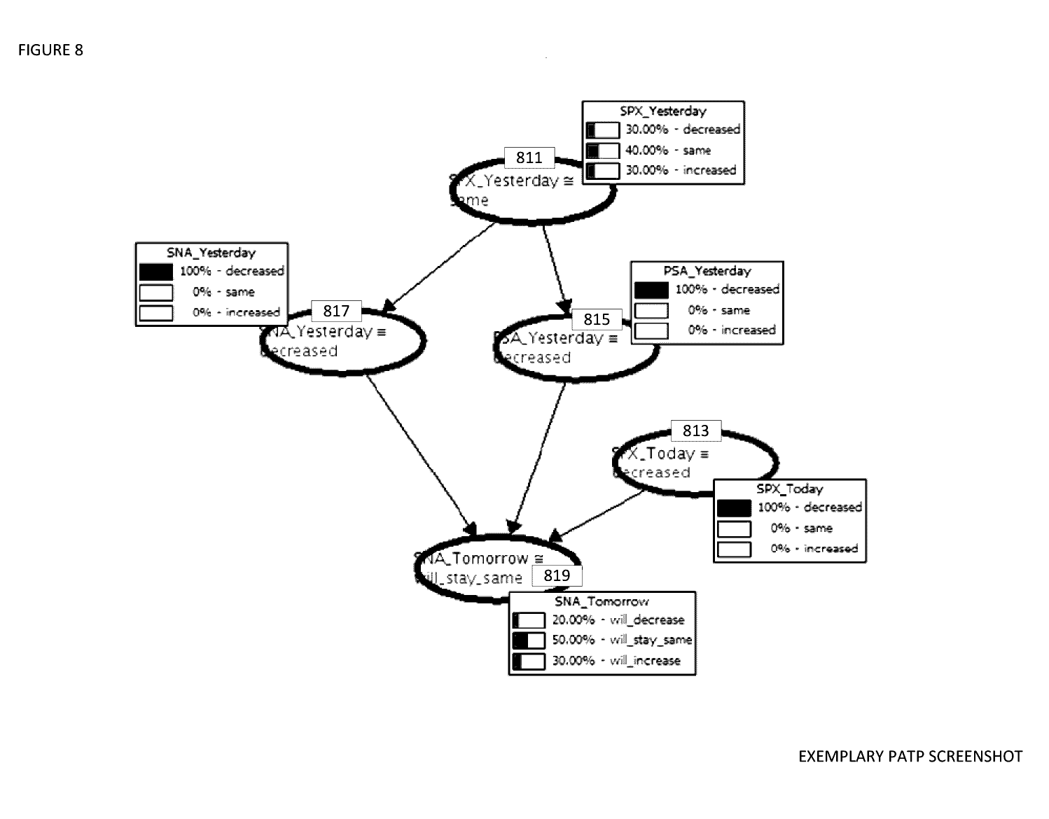

FIG. 8 shows a screenshot diagram illustrating embodiments of the PATP. In FIG. 8, additional details for the model shown in FIG. 6 are provided. Expected probabilities associated with nodes SPX_Today 811, SPX_Yesterday 813, PSA_Yesterday 815, SNA_Yesterday 817, and SNA_Tomorrow 819 are shown based on domain expert input data (e.g., a domain expert specified probabilities of 100% for price decreased outcome for nodes SPX_Today, PSA_Yesterday, SNA_Yesterday). Based on the provided domain expert input data, the probabilities for node SNA_Tomorrow are determined (e.g., price will decreased 20%, price will stay the same 50%, and price will increase 30%).

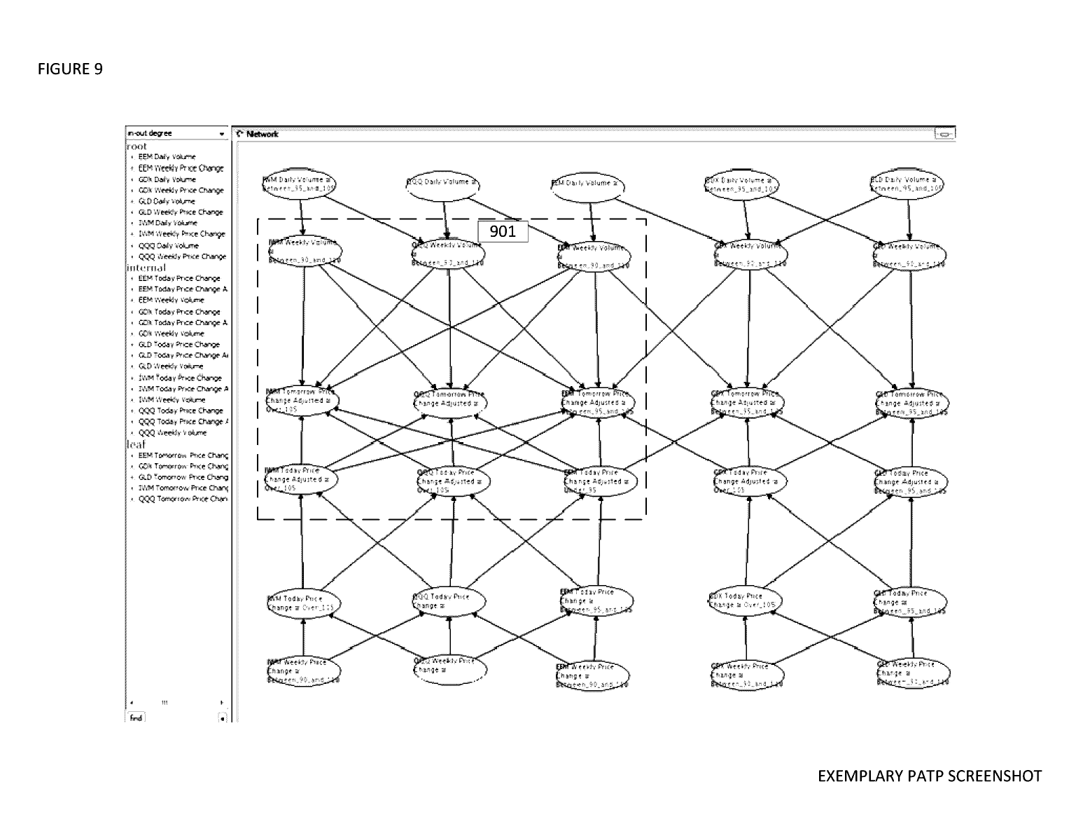

FIG. 9 shows a screenshot diagram illustrating embodiments of the PATP. In FIG. 9, another exemplary model is shown. This model deals with more securities (e.g., the model may predict prices for five different securities), utilizes nodes that deal with price changes and trading volume changes, and uses outcome values that are percentage changes as compared to the previous value (e.g. under 95%, between 95% and 105%, over 105%).

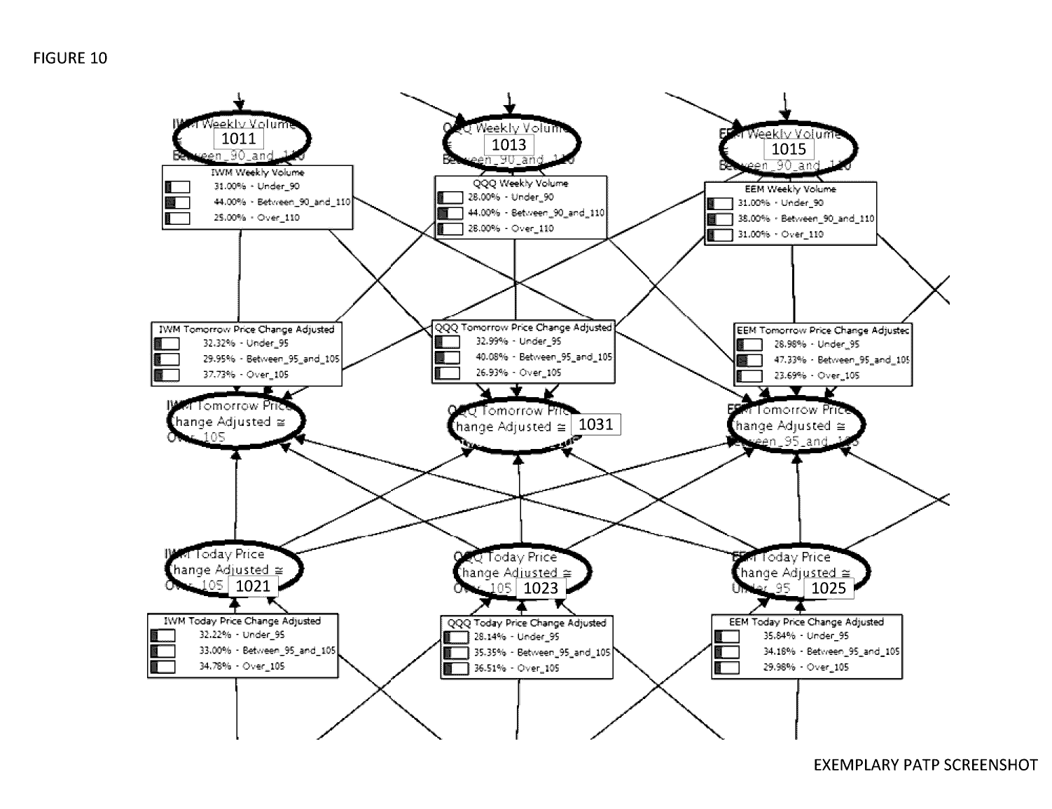

FIG. 10 shows a screenshot diagram illustrating embodiments of the PATP. In FIG. 10, additional details regarding marked section 901 of FIG. 9 are provided. Expected probabilities associated with nodes IWM Weekly Volume 1011, QQQ Weekly Volume 1013, EEM Weekly Volume 1015, IWM Today Price Change Adjusted 1021, QQQ Today Price Change Adjusted 1023, EEM Today Price Change Adjusted 1025, and QQQ Tomorrow Price Change Adjusted 1031 are shown. Node QQQ Tomorrow Price Change Adjusted (e.g., node indicating results of the analysis—predicting what happens to price of security QQQ tomorrow—the most likely value is that the price will be between 95% and 105% as compared to the previous day) is conditionally dependent on the other six nodes. Based on the probabilities for the six precedent nodes, the probabilities for node QQQ Tomorrow Price Change Adjusted are determined (e.g., 32.99% that price will be under 95%, 40.08% that price will be between 95% and 105%, and 26.93% that price will be over 105%).

In one implementation, data regarding nodes and/or data regarding calculating probabilities for nodes may be stored in HUGIN .NET file format. For example, data regarding the QQQ Tomorrow Price Change Adjusted node may be stored in a format similar to the following:

```
node QQQTomorrowPriceChangeAdjusted
{
  states = (“Under_95” “Between_95_and_105” “Over_105” );
  position = (310 -423);
  diagnosistype = “AUXILIARY”;
  DSLxSUBMODEL = “Root Submodel”;
  ismapvariable = “false”;
  ID = “variable0”;
  label = “QQQ Tomorrow Price Change Adjusted”;
  DSLxEXTRA_DEFINITIONxDIAGNOSIS_TYPE = “AUXILIARY”;
  excludepolicy = “include whole CPT”;
}
```

For example, data regarding calculating probabilities for the QQQ Tomorrow Price Change Adjusted node may be stored in a format similar to the following:

```
potential ( QQQTomorrowPriceChangeAdjusted |
QQQTodayPriceChangeAdjusted
          QQQWeeklyVolume
          IWMWeeklyVolume
          EEMWeeklyVolume
          IWMTodayPriceChangeAdjusted
          EEMTodayPriceChangeAdjusted )
{
  data =  (((((((  0.60.20.2)
        (  0.6  0.2  0.2)
        ...
        (  0.3  0.3  0.4)
        (  0.3  0.3  0.4)))))));
}
```

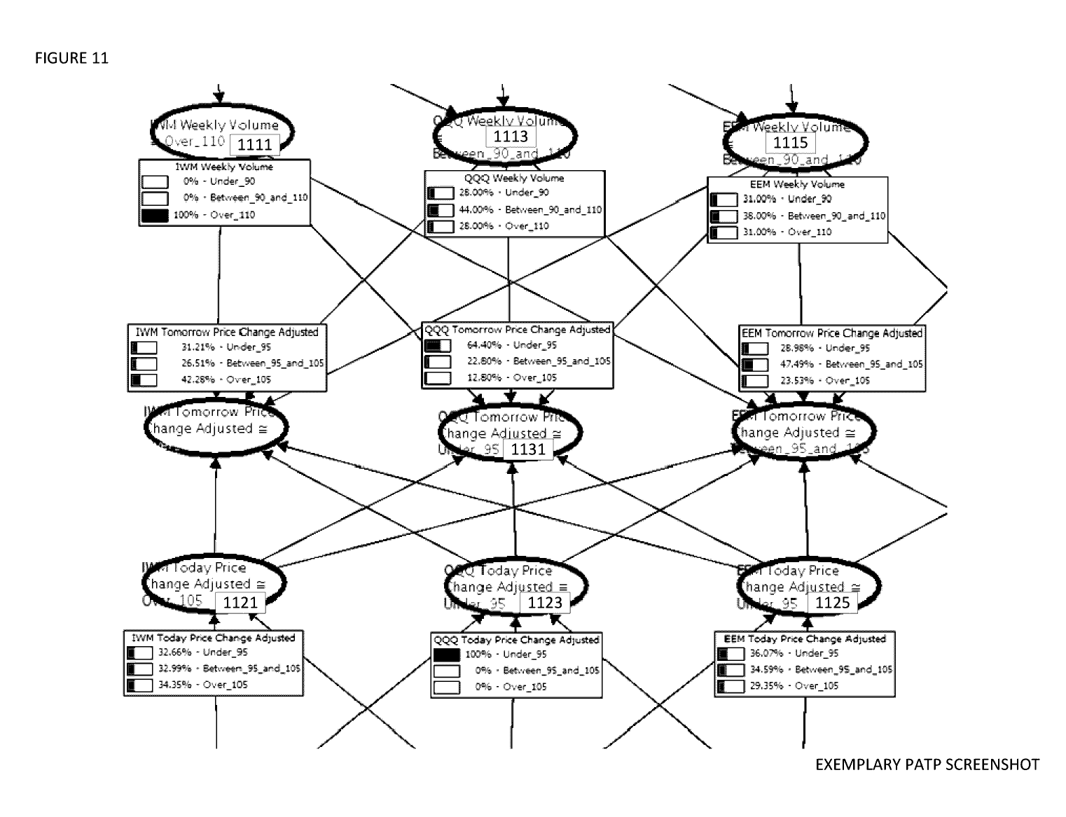

FIG. 11 shows a screenshot diagram illustrating embodiments of the PATP. In FIG. 11, additional details regarding marked section 901 of FIG. 9 are provided. Expected probabilities associated with nodes IWM Weekly Volume 1111, QQQ Weekly Volume 1113, EEM Weekly Volume 1115, IWM Today Price Change Adjusted 1121, QQQ Today Price Change Adjusted 1123, EEM Today Price Change Adjusted 1125, and QQQ Tomorrow Price Change Adjusted 1131 are shown based on domain expert input data (e.g., a domain expert specified probabilities of 100% that weekly volume is over 110% for node IWM Weekly Volume and 100% that price will be under 95% compared to the previous day for node QQQ Today Price Change Adjusted). Based on the provided domain expert input data, the probabilities for node QQQ Tomorrow Price Change Adjusted are recalculated (e.g., 64.4% that price will be under 95%, 22.8% that price will be between 95% and 105%, and 12.8% that price will be over 105%). Such a significant probability that price of QQQ will be under 95% (e.g., exceeding a predetermined 45% probability threshold) may indicate potentially anomalous market behavior. Accordingly, a trading action may be facilitated (e.g., based on a trading model for hedging, risk management or market advantage).

### PATP Controller

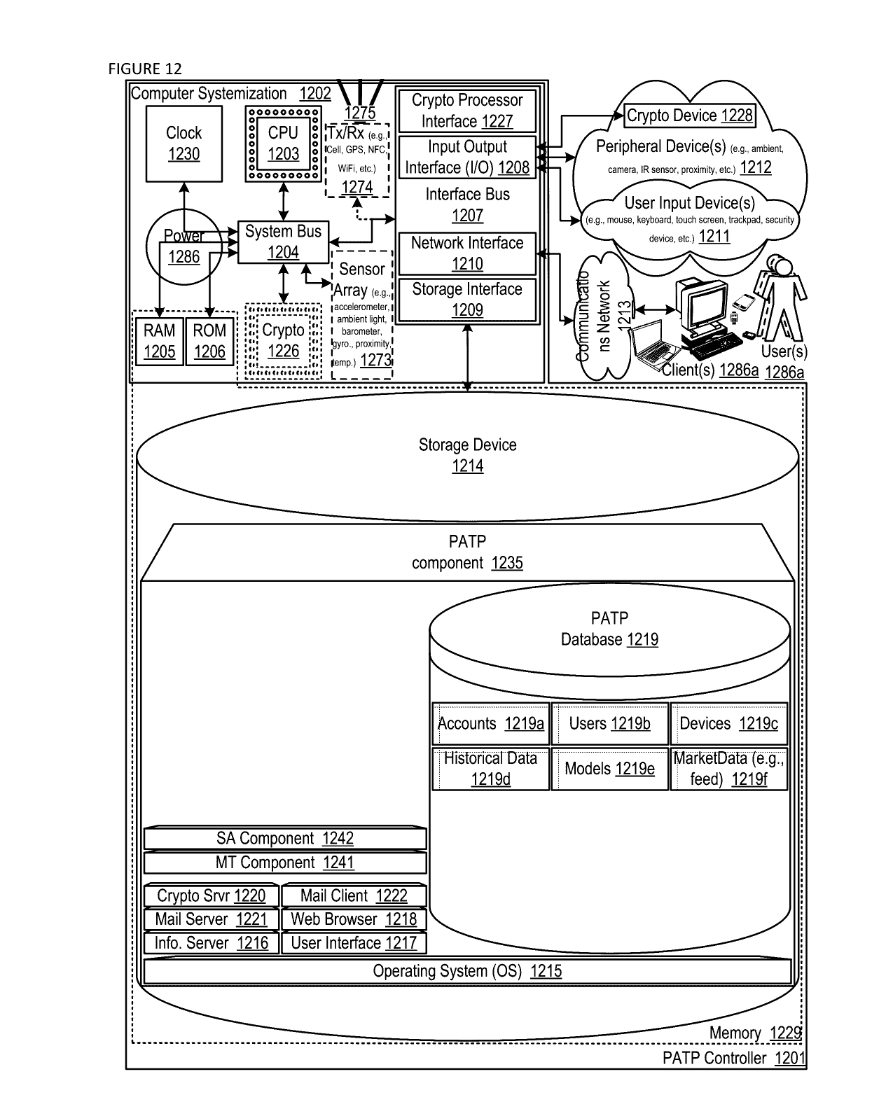

FIG. 12 shows a block diagram illustrating embodiments of a PATP controller. In this embodiment, the PATP controller 1201 may serve to aggregate, process, store, search, serve, identify, instruct, generate, match, and/or facilitate interactions with a computer through asset information technology technologies, and/or other related data.

Typically, users, which may be people and/or other systems, may engage information technology systems (e.g., computers) to facilitate information processing. In turn, computers employ processors to process information; such processors 1203 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 1229 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the PATP controller 1201 may be connected to and/or communicate with entities such as, but not limited to: one or more users from peripheral devices 1212 (e.g., user input devices 1211); an optional cryptographic processor device 1228; and/or a communications network 1213.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The PATP controller 1201 may be based on computer systems that may comprise, but are not limited to, components such as: a computer systemization 1202 connected to memory 1229.

### Computer Systemization

A computer systemization 1202 may comprise a clock 1230, central processing unit (“CPU(s)” and/or “processor(s)” (these terms are used interchangeable throughout the disclosure unless noted to the contrary)) 1203, a memory 1229 (e.g., a read only memory (ROM) 1206, a random access memory (RAM) 1205, etc.), and/or an interface bus 1207, and most frequently, although not necessarily, are all interconnected and/or communicating through a system bus 1204 on one or more (mother)board(s) 1202 having conductive and/or otherwise transportive circuit pathways through which instructions (e.g., binary encoded signals) may travel to effectuate communications, operations, storage, etc. The computer systemization may be connected to a power source 1286; e.g., optionally the power source may be internal. Optionally, a cryptographic processor 1226 may be connected to the system bus. In another embodiment, the cryptographic processor, transceivers (e.g., ICs) 1274, and/or sensor array (e.g., accelerometer, altimeter, ambient light, barometer, global positioning system (GPS) (thereby allowing PATP controller to determine its location), gyroscope, magnetometer, pedometer, proximity, ultra-violet sensor, etc.) 1273 may be connected as either internal and/or external peripheral devices 1212 via the interface bus I/O 1208 (not pictured) and/or directly via the interface bus 1207. In turn, the transceivers may be connected to antenna(s) 1275, thereby effectuating wireless transmission and reception of various communication and/or sensor protocols; for example the antenna(s) may connect to various transceiver chipsets (depending on deployment needs), including: Broadcom BCM4329FKUBG transceiver chip (e.g., providing 802.11n, Bluetooth 2.1+EDR, FM, etc.); a Broadcom BCM4752 GPS receiver with accelerometer, altimeter, GPS, gyroscope, magnetometer; a Broadcom BCM4335 transceiver chip (e.g., providing 2G, 3G, and 4G long-term evolution (LTE) cellular communications; 802.11ac, Bluetooth 4.0 low energy (LE) (e.g., beacon features)); a Broadcom BCM43341 transceiver chip (e.g., providing 2G, 3G and 4G LTE cellular communications; 802.11 g/, Bluetooth 4.0, near field communication (NFC), FM radio); an Infineon Technologies X-Gold 618-PMB9800 transceiver chip (e.g., providing 2G/3G HSDPA/HSUPA communications); a MediaTek MT6620 transceiver chip (e.g., providing 802.11a/ac/b/g/n, Bluetooth 4.0 LE, FM, GPS; a Lapis Semiconductor ML8511 UV sensor; a maxim integrated MAX44000 ambient light and infrared proximity sensor; a Texas Instruments WiLink WL1283 transceiver chip (e.g., providing 802.11n, Bluetooth 3.0, FM, GPS); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. The CPU is often packaged in a number of formats varying from large supercomputer(s) and mainframe(s) computers, down to mini computers, servers, desktop computers, laptops, thin clients (e.g., Chromebooks), netbooks, tablets (e.g., Android, iPads, and Windows tablets, etc.), mobile smartphones (e.g., Android, iPhones, Nokia, Palm and Windows phones, etc.), wearable device(s) (e.g., watches, glasses, goggles (e.g., Google Glass), etc.), and/or the like. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 1229 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; Apple's A series of processors (e.g., A5, A6, A7, A8, etc.); ARM's application, embedded and secure processors; IBM and/or Motorola's DragonBall and PowerPC; IBM's and Sony's Cell processor; Intel's 80X86 series (e.g., 80386, 80486), Pentium, Celeron, Core (2) Duo, i series (e.g., i3, i5, i7, etc.), Itanium, Xeon, and/or XScale; Motorola's 680X0 series (e.g., 68020, 68030, 68040, etc.); and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the PATP controller and beyond through various interfaces. Should processing requirements dictate a greater amount speed and/or capacity, distributed processors (e.g., see Distributed PATP below), mainframe, multi-core, parallel, and/or super-computer architectures may similarly be employed. Alternatively, should deployment requirements dictate greater portability, smaller mobile devices (e.g., Personal Digital Assistants (PDAs)) may be employed.

Depending on the particular implementation, features of the PATP may be achieved by implementing a microcontroller such as CAST's R8051XC2 microcontroller; Intel's MCS 51 (i.e., 8051 microcontroller); and/or the like. Also, to implement certain features of the PATP, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the PATP component collection (distributed or otherwise) and/or features may be implemented via the microprocessor and/or via embedded components; e.g., via ASIC, coprocessor, DSP, FPGA, and/or the like. Alternately, some implementations of the PATP may be implemented with embedded components that are configured and used to achieve a variety of features or signal processing.

Depending on the particular implementation, the embedded components may include software solutions, hardware solutions, and/or some combination of both hardware/software solutions. For example, PATP features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the PATP features. A hierarchy of programmable interconnects allow logic blocks to be interconnected as needed by the PATP system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the PATP may be developed on regular FPGAs and then migrated into a fixed version that more resembles ASIC implementations. Alternate or coordinating implementations may migrate PATP controller features to a final ASIC instead of or in addition to FPGAs. Depending on the implementation all of the aforementioned embedded components and microprocessors may be considered the “CPU” and/or “processor” for the PATP.

### Power Source

The power source 1286 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 1286 is connected to at least one of the interconnected subsequent components of the PATP thereby providing an electric current to all subsequent components. In one example, the power source 1286 is connected to the system bus component 1204. In an alternative embodiment, an outside power source 1286 is provided through a connection across the I/O 1208 interface. For example, a USB and/or IEEE 1394 connection carries both data and power across the connection and is therefore a suitable source of power.

### Interface Adapters

Interface bus(ses) 1207 may accept, connect, and/or communicate to a number of interface adapters, conventionally although not necessarily in the form of adapter cards, such as but not limited to: input output interfaces (I/O) 1208, storage interfaces 1209, network interfaces 1210, and/or the like. Optionally, cryptographic processor interfaces 1227 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X), PCI Express, Personal Computer Memory Card International Association (PCMCIA), and/or the like.

Storage interfaces 1209 may accept, communicate, and/or connect to a number of storage devices such as, but not limited to: storage devices 1214, removable disc devices, and/or the like. Storage interfaces may employ connection protocols such as, but not limited to: (Ultra) (Serial) Advanced Technology Attachment (Packet Interface) ((Ultra) (Serial) ATA(PI)) (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 1210 may accept, communicate, and/or connect to a communications network 1213. Through a communications network 1213, the PATP controller is accessible through remote clients 1233b (e.g., computers with web browsers) by users 1233a. Network interfaces may employ connection protocols such as, but not limited to: direct connect, Ethernet (thick, thin, twisted pair 10/100/1000/10000 Base T, and/or the like), Token Ring, wireless connection such as IEEE 802.11a-x, and/or the like. Should processing requirements dictate a greater amount speed and/or capacity, distributed network controllers (e.g., see Distributed PATP below), architectures may similarly be employed to pool, load balance, and/or otherwise decrease/increase the communicative bandwidth required by the PATP controller. A communications network may be any one and/or the combination of the following: a direct interconnection; the Internet; Interplanetary Internet (e.g., Coherent File Distribution Protocol (CFDP), Space Communications Protocol Specifications (SCPS), etc.); a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a cellular, WiFi, Wireless Application Protocol (WAP), I-mode, and/or the like); and/or the like. A network interface may be regarded as a specialized form of an input output interface. Further, multiple network interfaces 1210 may be used to engage with various communications network types 1213. For example, multiple network interfaces may be employed to allow for the communication over broadcast, multicast, and/or unicast networks.

Input Output interfaces (I/O) 1208 may accept, communicate, and/or connect to user, peripheral devices 1212 (e.g., input devices 1211), cryptographic processor devices 1228, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; touch interfaces: capacitive, optical, resistive, etc. displays; video interface: Apple Desktop Connector (ADC), BNC, coaxial, component, composite, digital, Digital Visual Interface (DVI), (mini) displayport, high-definition multimedia interface (HDMI), RCA, RF antennae, S-Video, VGA, and/or the like; wireless transceivers: 802.11a/ac/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

Peripheral devices 1212 may be connected and/or communicate to I/O and/or other facilities of the like such as network interfaces, storage interfaces, directly to the interface bus, system bus, the CPU, and/or the like. Peripheral devices may be external, internal and/or part of the PATP controller. Peripheral devices may include: antenna, audio devices (e.g., line-in, line-out, microphone input, speakers, etc.), cameras (e.g., gesture (e.g., Microsoft Kinect) detection, motion detection, still, video, webcam, etc.), dongles (e.g., for copy protection, ensuring secure transactions with a digital signature, and/or the like), external processors (for added capabilities; e.g., crypto devices 528), force-feedback devices (e.g., vibrating motors), infrared (IR) transceiver, network interfaces, printers, scanners, sensors/sensor arrays and peripheral extensions (e.g., ambient light, GPS, gyroscopes, proximity, temperature, etc.), storage devices, transceivers (e.g., cellular, GPS, etc.), video devices (e.g., goggles, monitors, etc.), video sources, visors, and/or the like. Peripheral devices often include types of input devices (e.g., cameras).

User input devices 1211 often are a type of peripheral device 512 (see above) and may include: card readers, dongles, finger print readers, gloves, graphics tablets, joysticks, keyboards, microphones, mouse (mice), remote controls, security/biometric devices (e.g., fingerprint reader, iris reader, retina reader, etc.), touch screens (e.g., capacitive, resistive, etc.), trackballs, trackpads, styluses, and/or the like.

It should be noted that although user input devices and peripheral devices may be employed, the PATP controller may be embodied as an embedded, dedicated, and/or monitor-less (i.e., headless) device, wherein access would be provided over a network interface connection.

Cryptographic units such as, but not limited to, microcontrollers, processors 1226, interfaces 1227, and/or devices 1228 may be attached, and/or communicate with the PATP controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: Broadcom's CryptoNetX and other Security Processors; nCipher's nShield; SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

### Memory

Generally, any mechanization and/or embodiment allowing a processor to affect the storage and/or retrieval of information is regarded as memory 1229. However, memory is a fungible technology and resource, thus, any number of memory embodiments may be employed in lieu of or in concert with one another. It is to be understood that the PATP controller and/or a computer systemization may employ various forms of memory 1229. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In a typical configuration, memory 1229 will include ROM 1206, RAM 1205, and a storage device 1214. A storage device 1214 may be any conventional computer system storage. Storage devices may include: an array of devices (e.g., Redundant Array of Independent Disks (RAID)); a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); RAM drives; solid state memory devices (USB memory, solid state drives (SSD), etc.); other processor-readable storage mediums; and/or other devices of the like. Thus, a computer systemization generally requires and makes use of memory.

### Component Collection

The memory 1229 may contain a collection of program and/or database components and/or data such as, but not limited to: operating system component(s) 1215 (operating system); information server component(s) 1216 (information server); user interface component(s) 1217 (user interface); Web browser component(s) 1218 (Web browser); database(s) 1219; mail server component(s) 1221; mail client component(s) 1222; cryptographic server component(s) 1220 (cryptographic server); the PATP component(s) 1235; and/or the like (i.e., collectively a component collection). These components may be stored and accessed from the storage devices and/or from storage devices accessible through an interface bus. Although non-conventional program components such as those in the component collection, typically, are stored in a local storage device 1214, they may also be loaded and/or stored in memory such as: peripheral devices, RAM, remote storage facilities through a communications network, ROM, various forms of memory, and/or the like.

### Operating System

The operating system component 1215 is an executable program component facilitating the operation of the PATP controller. Typically, the operating system facilitates access of I/O, network interfaces, peripheral devices, storage devices, and/or the like. The operating system may be a highly fault tolerant, scalable, and secure system such as: Apple's Macintosh OS X (Server); AT&T Plan 9; Be OS; Google's Chrome; Microsoft's Windows 7/8; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/Mobile/NT/Vista/XP (Server), Palm OS, and/or the like. Additionally, for robust mobile deployment applications, mobile operating systems may be used, such as: Apple's iOS; China Operating System COS; Google's Android; Microsoft Windows RT/Phone; Palm's WebOS; Samsung/Intel's Tizen; and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the PATP controller to communicate with other entities through a communications network 1213. Various communication protocols may be used by the PATP controller as a subcarrier transport mechanism for interaction, such as, but not limited to: multicast, TCP/IP, UDP, unicast, and/or the like.

### Information Server

An information server component 1216 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the PATP controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the PATP database 1219, operating systems, other program components, user interfaces, Web browsers, and/or the like.

Access to the PATP database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the PATP. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the PATP as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple's iOS, Macintosh Operating System's Aqua; IBM's OS/2; Google's Chrome (e.g., and other webbrowser/cloud based client OSs); Microsoft's Windows varied UIs 2000/2003/3.1/95/98/CE/Millenium/Mobile/NT/Vista/XP (Server) (i.e., Aero, Surface, etc.); Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 1217 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 1218 is a stored program component that is executed by a CPU. The Web browser may be a conventional hypertext viewing application such as Apple's (mobile) Safari, Google's Chrome, Microsoft Internet Explorer, Mozilla's Firefox, Netscape Navigator, and/or the like. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the PATP enabled nodes. The combined application may be nugatory on systems employing standard Web browsers.

### Mail Server

A mail server component 1221 is a stored program component that is executed by a CPU 1203. The mail server may be a conventional Internet mail server such as, but not limited to: dovecot, Courier IMAP, Cyrus IMAP, Maildir, Microsoft Exchange, sendmail, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the PATP. Alternatively, the mail server component may be distributed out to mail service providing entities such as Google's cloud services (e.g., Gmail and notifications may alternatively be provided via messenger services such as AOL's Instant Messenger, Apple's iMessage, Google Messenger, SnapChat, etc.).

Access to the PATP mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 1222 is a stored program component that is executed by a CPU 1203. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 1220 is a stored program component that is executed by a CPU 1203, cryptographic processor 1226, cryptographic processor interface 1227, cryptographic processor device 1228, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), Transport Layer Security (TLS), and/or the like. Employing such encryption security protocols, the PATP may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the PATP component to engage in secure transactions if so desired. The cryptographic component facilitates the secure accessing of resources on the PATP and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The PATP Database

The PATP database component 1219 may be embodied in a database and its stored data. The database is a stored program component, which is executed by the CPU; the stored program component portion configuring the CPU to process the stored data. The database may be a conventional, fault tolerant, relational, scalable, secure database such as MySQL, Oracle, Sybase, etc. may be used. Additionally, optimized fast memory and distributed databases such as IBM's Netezza, MongoDB's MongoDB, opensource Hadoop, opensource VoltDB, SAP's Hana, etc. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. Alternative key fields may be used from any of the fields having unique value sets, and in some alternatives, even non-unique values in combinations with other fields. More precisely, they uniquely identify rows of a table on the “one” side of a one-to-many relationship.

Alternatively, the PATP database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the PATP database is implemented as a data-structure, the use of the PATP database 1219 may be integrated into another component such as the PATP component 1235. Also, the database may be implemented as a mix of data structures, objects, and relational structures. Databases may be consolidated and/or distributed in countless variations (e.g., see Distributed PATP below). Portions of databases, e.g., tables, may be exported and/or imported and thus decentralized and/or integrated.

In one embodiment, the database component 1219 includes several tables 1219a-f:

An accounts table 1219a includes fields such as, but not limited to: an accountID, accountOwnerID, accountContactID, assetIDs, deviceIDs, paymentIDs, transactionIDs, userIDs, accountType (e.g., agent, entity (e.g., corporate, non-profit, partnership, etc.), individual, etc.), accountCreationDate, accountUpdateDate, accountName, accountNumber, routingNumber, accountAddress, accountState, accountZlPcode, accountCountry, accountEmail, accountPhone, accountAuthKey, accountIPaddress, accountURLAccessCode, accountPortNo, accountAuthorizationCode, accountAccessPrivileges, accountPreferences, accountRestrictions, and/or the like;

A users table 1219b includes fields such as, but not limited to: a userID, userSSN, taxID, userContactID, accountID, assetIDs, deviceIDs, paymentIDs, transactionIDs, userType (e.g., agent, entity (e.g., corporate, non-profit, partnership, etc.), individual, etc.), namePrefix, firstName, middleName, lastName, nameSuffix, DateOfBirth, userAge, userName, userEmail, userSocialAccountID, contactType, contactRelationship, userPhone, userAddress, userCity, userState, userZIPCode, userCountry, userAuthorizationCode, userAccessPrivilges, userPreferences, userRestrictions, and/or the like (the user table may support and/or track multiple entity accounts on a PATP);

An devices table 1219c includes fields such as, but not limited to: deviceID, sensorIDs, accountID, assetIDs, paymentIDs, deviceType, deviceName, deviceManufacturer, deviceModel, deviceVersion, deviceSerialNo, deviceIPaddress, deviceMACaddress, device_ECID, deviceUUID, deviceLocation, deviceCertificate, deviceOS, appIDs, deviceResources, deviceSession, authKey, deviceSecureKey, walletAppInstalledFlag, deviceAccessPrivileges, devicePreferences, deviceRestrictions, hardware_config, software_config, storage_location, sensor_value, pin_reading, data_length, channel_requirement, sensor_name, sensor_model_no, sensor_manufacturer, sensor_type, sensor_serial_number, sensor_power_requirement, device_power_requirement, location, sensor_associated_tool, sensor_dimensions, device_dimensions, sensor_communications_type, device_communications_type, power_percentage, power_condition, temperature_setting, speed_adjust, hold_duration, part_actuation, and/or the like. Device table may, in some embodiments, include fields corresponding to one or more Bluetooth profiles, such as those published at https://www.bluetooth.org/en-us/specification/adopted-specifications, and/or other device specifications, and/or the like;

A historical data table 1219d includes fields such as, but not limited to: historicalSecurityID, historicalSecurityName, historicalSecurityType, historicalSecurityExchange, historicalSecurityFundamentalsValues, historicalSecurityPrices, historicalSecurityTradedVolumes, and/or the like;

A models table 1219e includes fields such as, but not limited to: modelID, modelParameters, modelSecurities, modelNodes, modelNodeDependencies, nodeID, nodeName, nodeInputs, nodeValue, nodeOutcomes, nodeProbabilities, and/or the like;

A market_data table 1219f includes fields such as, but not limited to: market_data_feed_ID, asset_ID, asset_symbol, asset_name, spot_price, bid_price, ask_price, and/or the like; in one embodiment, the market data table is populated through a market data feed (e.g., Bloomberg's PhatPipe, Consolidated Quote System (CQS), Consolidated Tape Association (CTA), Consolidated Tape System (CTS), Dun & Bradstreet, OTC Montage Data Feed (OMDF), Reuter's Tib, Triarch, US equity trade and quote market data, Unlisted Trading Privileges (UTP) Trade Data Feed (UTDF), UTP Quotation Data Feed (UQDF), and/or the like feeds, e.g., via ITC 2.1 and/or respective feed protocols), for example, through Microsoft's Active Template Library and Dealing Object Technology's real-time toolkit Rtt.Multi.

In one embodiment, the PATP database may interact with other database systems. For example, employing a distributed database system, queries and data access by search PATP component may treat the combination of the PATP database, an integrated data security layer database as a single database entity (e.g., see Distributed PATP below).

In one embodiment, user programs may contain various user interface primitives, which may serve to update the PATP. Also, various accounts may require custom database tables depending upon the environments and the types of clients the PATP may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 1219a-f. The PATP may be configured to keep track of various settings, inputs, and parameters via database controllers.

The PATP database may communicate to and/or with other components in a component collection, including itself, and/or facilities of the like. Most frequently, the PATP database communicates with the PATP component, other program components, and/or the like. The database may contain, retain, and provide information regarding other nodes and data.

### The PATPs

The PATP component 1235 is a stored program component that is executed by a CPU. In one embodiment, the PATP component incorporates any and/or all combinations of the aspects of the PATP that was discussed in the previous figures. As such, the PATP affects accessing, obtaining and the provision of information, services, transactions, and/or the like across various communications networks. The features and embodiments of the PATP discussed herein increase network efficiency by reducing data transfer requirements the use of more efficient data structures and mechanisms for their transfer and storage. As a consequence, more data may be transferred in less time, and latencies with regard to transactions, are also reduced. In many cases, such reduction in storage, transfer time, bandwidth requirements, latencies, etc., will reduce the capacity and structural infrastructure requirements to support the PATP's features and facilities, and in many cases reduce the costs, energy consumption/requirements, and extend the life of PATP's underlying infrastructure; this has the added benefit of making the PATP more reliable. Similarly, many of the features and mechanisms are designed to be easier for users to use and access, thereby broadening the audience that may enjoy/employ and exploit the feature sets of the PATP; such ease of use also helps to increase the reliability of the PATP. In addition, the feature sets include heightened security as noted via the Cryptographic components 1220, 1226, 1228 and throughout, making access to the features and data more reliable and secure.

The PATP transforms model training request and security analysis request inputs, via PATP components (e.g., MT, SA), into model parameters data, model training response, order request, and security analysis response outputs.

The PATP component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the PATP server employs a cryptographic server to encrypt and decrypt communications. The PATP component may communicate to and/or with other components in a component collection, including itself, and/or facilities of the like. Most frequently, the PATP component communicates with the PATP database, operating systems, other program components, and/or the like. The PATP may contain, communicate, generate, obtain, and/or provide program component, system, user, and/or data communications, requests, and/or responses.

### Distributed PATPs

The structure and/or operation of any of the PATP node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion. As such a combination of hardware may be distributed within a location, within a region and/or globally where logical access to a controller may be abstracted as a singular node, yet where a multitude of private, semiprivate and publically accessible node controllers (e.g., via dispersed data centers) are coordinated to serve requests (e.g., providing private cloud, semi-private cloud, and public cloud computing resources) and allowing for the serving of such requests in discrete regions (e.g., isolated, local, regional, national, global cloud access).

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the PATP controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like. For example, cloud services such as Amazon Data Services, Microsoft Azure, Hewlett Packard Helion, IBM Cloud services allow for PATP controller and/or PATP component collections to be hosted in full or partially for varying degrees of scale.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the PATP controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

```
<?PHP
header(′Content-Type: text/plain′);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until end
of message
do {
    $input = “”;
    $input = socket_read($client, 1024);
    $data .= $input;
} while($input != “”;
// parse data to extract variables
$obj = json_decode($data, true);
// store input data in a database
mysql_connect(″201.408.185.132″,$DBserver,$password); // access
database server
mysql_select(″CLIENT_DB.SQL″); // select database to append
mysql_query(“INSERT INTO UserTable (transmission)
VALUES ($data)”); // add data to UserTable table in a CLIENT database
mysql_close(″CLIENT_DB.SQL″); // close connection to database
?>
```

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/
index.jsp?topic=/com.ibm
.IBMDI.doc/referenceguide295.htm

and other parser implementations:

http://publib.boulder.ibm.com/infocenter/tivihelp/v2r1/
index.jsp?topic=/com.ibm
.IBMDI.doc/referenceguide259.htm

all of which are hereby expressly incorporated by reference.

In order to address various issues and advance the art, the entirety of this application for Probabilistic Analysis Trading Platform Apparatuses, Methods and Systems (including the Cover Page, Tide, Headings, Field, Background, Summary, Brief Description of the Drawings, Detailed Description, Claims, Abstract, Figures, Appendices, and otherwise) shows, by way of illustration, various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components, data flow order, logic flow order, and/or any present feature sets as described in the figures and/or throughout are not limited to a fixed operating order and/or arrangement, but rather, any disclosed order is exemplary and all equivalents, regardless of order, are contemplated by the disclosure. Similarly, descriptions of embodiments disclosed throughout this disclosure, any reference to direction or orientation is merely intended for convenience of description and is not intended in any way to limit the scope of described embodiments. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should not be construed to limit embodiments, and instead, again, are offered for convenience of description of orientation. These relative descriptors are for convenience of description only and do not require that any embodiments be constructed or operated in a particular orientation unless explicitly indicated as such. Terms such as “attached,” “affixed,” “connected,” “coupled,” “interconnected,” and similar may refer to a relationship wherein structures are secured or attached to one another either directly or indirectly through intervening structures, as well as both movable or rigid attachments or relationships, unless expressly described otherwise. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations in part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a PATP individual and/or enterprise user, database configuration and/or relational model, data type, data transmission and/or network framework, syntax structure, and/or the like, various embodiments of the PATP, may be implemented that enable a great deal of flexibility and customization. For example, aspects of the PATP may be adapted for trading securities and/or other assets that are not traded on securities exchanges. While various embodiments and discussions of the PATP have included asset information technology, however, it is to be understood that the embodiments described herein may be readily configured and/or customized for a wide variety of other applications and/or implementations.

What is claimed is:

1. A security analyzing apparatus, comprising:
a memory;
a component collection in the memory, including:
a security analysis component;
a processor disposed in communication with the memory, and configured to issue a plurality of processing instructions from the component collection stored in the memory,
wherein the processor issues instructions from the security analysis component, stored in the memory, to:
obtain a security analysis request associated with a security via the security analysis component;
retrieve, via processor, model parameters of a model associated with the security;
determine, via processor, modified nodes of the model, wherein the modified nodes are nodes for which probabilities have been modified by expert input data associated with the security analysis request;
determine, via processor, dependent nodes for each of the modified nodes;
recalculate, via processor, probabilities associated with each of the dependent nodes;
determine, via processor, an output value associated with a result node of the model based on the recalculated probabilities; and
facilitate, via processor, a trading action based on the output value.

2. The apparatus of claim 1, further, comprising:
the processor issues instructions from the security analysis component, stored in the memory, to:
determine the model associated with the security based on an identifier of the model provided in the security analysis request.

3. The apparatus of claim 1, further, comprising:
the processor issues instructions from the security analysis component, stored in the memory, to:
determine the model associated with the security based on an identifier of the security provided in the security analysis request.

4. The apparatus of claim 1, wherein instructions to determine modified nodes further comprise instructions to determine a modified node for which probabilities associated with an input of the modified node have been modified by the expert input data.

5. The apparatus of claim 1, wherein instructions to determine modified nodes further comprise instructions to determine a modified node for which probabilities associated with outcomes of the modified node have been modified by the expert input data.

6. The apparatus of claim 1, wherein instructions to determine dependent nodes further comprise instructions to determine a dependent node that depends directly on a modified node.

7. The apparatus of claim 1, wherein instructions to determine dependent nodes further comprise instructions to determine a dependent node that depends indirectly on a modified node.

8. The apparatus of claim 1, wherein instructions to recalculate probabilities associated with a dependent node further comprise instructions to calculate modified unconditional probabilities associated with an input of the dependent node.

9. The apparatus of claim 1, wherein instructions to recalculate probabilities associated with a dependent node further comprise instructions to calculate modified conditional probabilities associated with an outcome of the dependent node.

10. The apparatus of claim 9, wherein modified conditional probabilities are calculated using a naive Bayes classifier.

11. The apparatus of claim 1, wherein the output value is goal probabilities associated with each outcome of the result node.

12. The apparatus of claim 1, wherein the result node is a leaf node.

13. The apparatus of claim 1, wherein the trading action is facilitated based on the most likely outcome of the result node.

14. The apparatus of claim 1, wherein the trading action is facilitated based on a threshold value of an outcome of the result node.

15. The apparatus of claim 1, wherein the security is one of an individual security and an index security, and wherein the trading action is one of buying the security, selling the security, buying an option on the security, selling an option on the security.

16. The apparatus of claim 1, wherein a node utilizes inputs that are based on fundamental financial analysis parameters.

17. The apparatus of claim 1, wherein a node utilizes inputs that are based on trend analysis parameters.

18. The apparatus of claim 1, wherein a security is any of: physical asset, bond, note, fund, equity, ETF, funds, pool, mutual fund, and derivative.

19. A processor-readable security analyzing non-transient physical medium storing processor-executable components, the components, comprising:
a component collection stored in the medium, including:
a security analysis component;
wherein the security analysis component, stored in the medium, includes processor-issuable instructions to:
obtain a security analysis request associated with a security via the security analysis component;
retrieve, via processor, model parameters of a model associated with the security;
determine, via processor, modified nodes of the model, wherein the modified nodes are nodes for which probabilities have been modified by expert input data associated with the security analysis request;
determine, via processor, dependent nodes for each of the modified nodes;
recalculate, via processor, probabilities associated with each of the dependent nodes;
determine, via processor, an output value associated with a result node of the model based on the recalculated probabilities; and
facilitate, via processor, a trading action based on the output value.

20. The apparatus of claim 19, further, comprising:
the security analysis component, stored in the medium, includes processor-issuable instructions to:
determine the model associated with the security based on an identifier of the model provided in the security analysis request.

21. The medium of claim 19, further, comprising:
the security analysis component, stored in the medium, includes processor-issuable instructions to:
determine the model associated with the security based on an identifier of the security provided in the security analysis request.

22. The medium of claim 19, wherein instructions to determine modified nodes further comprise instructions to determine a modified node for which probabilities associated with an input of the modified node have been modified by the expert input data.

23. The medium of claim 19, wherein instructions to determine modified nodes further comprise instructions to determine a modified node for which probabilities associated with outcomes of the modified node have been modified by the expert input data.

24. The medium of claim 19, wherein instructions to determine dependent nodes further comprise instructions to determine a dependent node that depends directly on a modified node.

25. The medium of claim 19, wherein instructions to determine dependent nodes further comprise instructions to determine a dependent node that depends indirectly on a modified node.

26. The medium of claim 19, wherein instructions to recalculate probabilities associated with a dependent node further comprise instructions to calculate modified unconditional probabilities associated with an input of the dependent node.

27. The medium of claim 19, wherein instructions to recalculate probabilities associated with a dependent node further comprise instructions to calculate modified conditional probabilities associated with an outcome of the dependent node.

28. The medium of claim 27, wherein modified conditional probabilities are calculated using a naive Bayes classifier.

29. The medium of claim 19, wherein the output value is goal probabilities associated with each outcome of the result node.

30. The medium of claim 19, wherein the result node is a leaf node.

31. The medium of claim 19, wherein the trading action is facilitated based on the most likely outcome of the result node.

32. The medium of claim 19, wherein the trading action is facilitated based on a threshold value of an outcome of the result node.

33. The medium of claim 19, wherein the security is one of an individual security and an index security, and wherein the trading action is one of buying the security, selling the security, buying an option on the security, selling an option on the security.

34. The medium of claim 19, wherein a node utilizes inputs that are based on fundamental financial analysis parameters.

35. The medium of claim 19, wherein a node utilizes inputs that are based on trend analysis parameters.

36. The medium of claim 19, wherein a security is any of: physical asset, bond, note, fund, equity, ETF, funds, pool, mutual fund, and derivative.

37. A processor-implemented security analyzing system, comprising:
a security analysis component means, to:
obtain a security analysis request associated with a security via the security analysis component;
retrieve, via processor, model parameters of a model associated with the security;
determine, via processor, modified nodes of the model, wherein the modified nodes are nodes for which probabilities have been modified by expert input data associated with the security analysis request;
determine, via processor, dependent nodes for each of the modified nodes;
recalculate, via processor, probabilities associated with each of the dependent nodes;
determine, via processor, an output value associated with a result node of the model based on the recalculated probabilities; and
facilitate, via processor, a trading action based on the output value.

38. The system of claim 37, further, comprising:
the security analysis component means, to:
determine the model associated with the security based on an identifier of the model provided in the security analysis request.

39. The system of claim 37, further, comprising:
the security analysis component means, to:
determine the model associated with the security based on an identifier of the security provided in the security analysis request.

40. The system of claim 37, wherein means to determine modified nodes further comprise means to determine a modified node for which probabilities associated with an input of the modified node have been modified by the expert input data.

41. The system of claim 37, wherein means to determine modified nodes further comprise means to determine a modified node for which probabilities associated with outcomes of the modified node have been modified by the expert input data.

42. The system of claim 37, wherein means to determine dependent nodes further comprise means to determine a dependent node that depends directly on a modified node.

43. The system of claim 37, wherein means to determine dependent nodes further comprise means to determine a dependent node that depends indirectly on a modified node.

44. The system of claim 37, wherein means to recalculate probabilities associated with a dependent node further comprise means to calculate modified unconditional probabilities associated with an input of the dependent node.

45. The system of claim 37, wherein means to recalculate probabilities associated with a dependent node further comprise means to calculate modified conditional probabilities associated with an outcome of the dependent node.

46. The system of claim 45, wherein modified conditional probabilities are calculated using a naive Bayes classifier.

47. The system of claim 37, wherein the output value is goal probabilities associated with each outcome of the result node.

48. The system of claim 37, wherein the result node is a leaf node.

49. The system of claim 37, wherein the trading action is facilitated based on the most likely outcome of the result node.

50. The system of claim 37, wherein the trading action is facilitated based on a threshold value of an outcome of the result node.

51. The system of claim 37, wherein the security is one of an individual security and an index security, and wherein the trading action is one of buying the security, selling the security, buying an option on the security, selling an option on the security.

52. The system of claim 37, wherein a node utilizes inputs that are based on fundamental financial analysis parameters.

53. The system of claim 37, wherein a node utilizes inputs that are based on trend analysis parameters.

54. The system of claim 37, wherein a security is any of: physical asset, bond, note, fund, equity, ETF, funds, pool, mutual fund, and derivative.

55. A processor-implemented security analyzing method to transform a security analysis request into a trading action, comprising:
executing processor-implemented security analysis component instructions to:
obtain a security analysis request associated with a security via the security analysis component;
retrieve, via processor, model parameters of a model associated with the security;
determine, via processor, modified nodes of the model, wherein the modified nodes are nodes for which probabilities have been modified by expert input data associated with the security analysis request;
determine, via processor, dependent nodes for each of the modified nodes;
recalculate, via processor, probabilities associated with each of the dependent nodes;
determine, via processor, an output value associated with a result node of the model based on the recalculated probabilities; and
facilitate, via processor, a trading action based on the output value.

56. The method of claim 55, further, comprising:
executing processor-implemented security analysis component instructions to:
determine the model associated with the security based on an identifier of the model provided in the security analysis request.

57. The method of claim 55, further, comprising:
executing processor-implemented security analysis component instructions to:
determine the model associated with the security based on an identifier of the security provided in the security analysis request.

58. The method of claim 55, wherein instructions to determine modified nodes further comprise instructions to determine a modified node for which probabilities associated with an input of the modified node have been modified by the expert input data.

59. The method of claim 55, wherein instructions to determine modified nodes further comprise instructions to determine a modified node for which probabilities associated with outcomes of the modified node have been modified by the expert input data.

60. The method of claim 55, wherein instructions to determine dependent nodes further comprise instructions to determine a dependent node that depends directly on a modified node.

61. The method of claim 55, wherein instructions to determine dependent nodes further comprise instructions to determine a dependent node that depends indirectly on a modified node.

62. The method of claim 55, wherein instructions to recalculate probabilities associated with a dependent node further comprise instructions to calculate modified unconditional probabilities associated with an input of the dependent node.

63. The method of claim 55, wherein instructions to recalculate probabilities associated with a dependent node further comprise instructions to calculate modified conditional probabilities associated with an outcome of the dependent node.

64. The method of claim 63, wherein modified conditional probabilities are calculated using a naive Bayes classifier.

65. The method of claim 55, wherein the output value is goal probabilities associated with each outcome of the result node.

66. The method of claim 55, wherein the result node is a leaf node.

67. The method of claim 55, wherein the trading action is facilitated based on the most likely outcome of the result node.

68. The method of claim 55, wherein the trading action is facilitated based on a threshold value of an outcome of the result node.

69. The method of claim 55, wherein the security is one of an individual security and an index security, and wherein the trading action is one of buying the security, selling the security, buying an option on the security, selling an option on the security.

70. The method of claim 55, wherein a node utilizes inputs that are based on fundamental financial analysis parameters.

71. The method of claim 55, wherein a node utilizes inputs that are based on trend analysis parameters.

72. The method of claim 55, wherein a security is any of: physical asset, bond, note, fund, equity, ETF, funds, pool, mutual fund, and derivative.
